(19) United States
(12) Patent Application Publication
(10) Pub. No.: US 2026/0214039 A1
(43) Pub. Date: Jul. 23, 2026

(54) RTT and One-Way Latency Measurements using Latency Spin Bits

(71) Applicant: Telefonaktiebolaget LM Ericsson (publ), Stockholm (SE)

(72) Inventors: Kun Wang, Solna (SE); Attila Báder, Paty (HU); Hans Hannu, Luleå (SE)

(21) Appl. No.: 19/138,776

(22) PCT Filed: Dec. 16, 2022
(86) PCT No.: PCT/SE2022/051190

§ 371 Date: Jun. 13, 2025

(51) Int. Cl. H04L 43/0864; H04L 43/0852

(52) U.S. Cl. CPC H04L 43/0864; H04L 43/0858

(57) ABSTRACT

Systems and methods are disclosed for measuring Round Trip Time (RTT) and, in some embodiments, one-way latency between nodes of a cellular communications system. In one embodiment, a method performed by an observation function comprises observing, at a first time in a first direction of a communication path between first and second nodes of a cellular communications system, a packet with a first latency spin bit at or above a Packet Data Convergence Protocol (PDCP) layer set to a first value and storing the first time. The method further comprises observing, at a second time in the first direction of the communication path between the first and second nodes, a packet with the first latency spin bit set to a second value and storing the second time. The method further comprises computing a RTT as a difference of the second time and the first time.

### TECHNICAL FIELD

The present disclosure relates to a cellular communications system and, more specifically, to determining Round Trip Times (RTTs) and one-way latencies between nodes of a cellular communications system.

### BACKGROUND

The QUIC, which is described in the Internet Engineering Task Force (IETF) Request For Comments (RFC) 9000 entitled “QUIC: A UDP-Based Multiplexed and Secure Transport”, is a general purposes transport protocol. Note that “QUIC” is not an acronym, rather it is the name given to the protocol described in RFC 9000. Endpoints communicate in QUIC by exchanging QUIC packets. Most packets contain frames, which carry control information and application data between endpoints. QUIC authenticates the entirety of each packet and encrypts as much of each packet as is practical. QUIC packets are carried in User Datagram Protocol (UDP) datagrams to better facilitate deployment in existing systems and networks. QUIC provides the necessary feedback to implement reliable delivery and congestion control.

QUIC enables passive latency monitoring from observation points along the network path via the Latency Spin Bit defined for 1-Round Trip Time (RTT) packets. For this passive latency monitoring, when a server receives a packet within a connection, the server reflects the value of the Latency Spin Bit (i.e., the spin value) in a packet(s) sent back to the client, while the client “spins” the Latency Spin Bit after one RTT. Hence, observers on the path can measure the time between two spin bit value toggle events to estimate the end-to-end RTT of a connection.

An example is given in FIG. 1 where the observer observes the RTT seen in both directions. The client starts sending packets with a first spin value represented by a first line, and the server reflects the spin value and sends packets toward the client with the same spin value. The observer stores the times Tᵤᵣ and T_{dr}. When the client receives the packets with the first spin value from the server, the client spins the value of the latency spin bit for packets toward the server (represented by a second line). The server reflects the value of the latency spin bit in these packets and sends packets toward the client with the same latency spin bit value. The observer stores the times T_{ub} and T_{db} when it observes that the latency spin bit value has changed yet again. Now, using these stored times, the observer makes a first estimate of the RTT between the two endpoints, i.e.: RTTᵤ₁=T_{ub}−Tᵤᵣ and RTT_{d1}=T_{db}−T_{dr}. The two RTT estimates, RTTᵤ₁ and RTT_{d1}, will likely have the same RTT estimate, but here both are shown both in case the observer looks on only the UL and DL direction.

In cellular communication systems, there is also a need to measure performance metrics such as throughput, latency, and packet losses. Therefore, substantial effort is put into defining such performance metrics and measurements for these performance metrics. The 3^{rd} Generation Partnership Project (3GPP) has specified several performance measurements and Key Performance Indicators (KPIs) for the 5^{th} Generation System (5GS). In particular, 3GPP Technical Specification (TS) 28.554 (see, e.g., V17.8.0) defines KPIs, while 3GPP TS 28.552 (see, e.g., V17.8.0) defines performance measurements for the Next Generation Radio Access Network (NG-RAN) and the 5^{th} Generation Core (5GC). Further, 3GPP TS 38.314 (see, e.g., V17.1.0) clarifies some layer 2 (L2) measurements related to the NG-RAN metrics in 3GPP TS 28.552.

### SUMMARY

Systems and methods are disclosed for measuring Round Trip Time (RTT) and, in some embodiments, one-way latency between nodes of a cellular communications system using one or more latency spin bits. In one embodiment, a method performed by an observation function in a cellular communications system comprises observing, at a first time in a first direction of a communication path between a first node of a cellular communications system and a second node of the cellular communications system, a packet with a first latency spin bit set to a first value and storing the first time. The method further comprises observing, at a second time in the first direction of the communication path between the first node of the cellular communications system and the second node of the cellular communications system, a packet with the first latency spin bit set to a second value and storing the second time. The method further comprises computing a RTT for communication between the first node and the second node as a difference of the second time and the first time. The first latency spin bit is comprised in each of the packets at or above a Packet Data Convergence Protocol (PDCP) layer in a defined protocol stack of the cellular communications system. In this manner, the RTT can be determined in an efficient manner.

In one embodiment, the method is applied for Ultra-Reliable Low-Latency Communication (URLLC) traffic. In another embodiment, the method is applied for real-time traffic. In another embodiment, the method is applied for Real Time Protocol (RTP) traffic over User Datagram Protocol (UDP).

In one embodiment, the first node is a User Equipment (UE), and the second node is a base station. In one embodiment, the first direction of the communication path is an uplink direction. In another embodiment, the first direction of the communication path is a downlink direction. In one embodiment, the first latency spin bit is comprised in a PDCP header or an extension of a PDCP header. In another embodiment, the first latency spin bit is comprised in a Service Data Adaptation Protocol (SDAP) header or an extension of a SDAP header.

In one embodiment, the first node is a base station, and the second node is a core network node. In one embodiment, the core network node is a User Plane Function (UPF). In one embodiment, the first latency spin bit is comprised in a General Packet Radio Service (GPRS) Tunneling Protocol (GTP) header or an extension of a GTP header.

In one embodiment, the observation function is implemented at the second node. In another embodiment, the observation function is implemented at the first node. In another embodiment, the observation function is implemented at a third node that is in the communication path between the first node and the second node.

In one embodiment, the first node is a UE, and the second node is a core network node. In one embodiment, the core network node is a User Plane Function (UPF). In one embodiment, the observation function is implemented at a base station in the communication path between the UE and the core network node.

In one embodiment, the method further comprises observing, at a third time (T₃) in a second direction of the communication path between the first node of the cellular communications system and the second node of the cellular communications system, a packet that includes the first latency spin bit set to the second value and storing the time (T₃). The method further comprises observing, at a fourth time (T₄) in the second direction of the communication path between the first node of the cellular communications system and the second node of the cellular communications system, a packet that includes a second latency spin bit that has been toggled and storing the fourth time (T₄). The method further comprises computing a one-way latency for the first direction of the communication path between the first node of the cellular communications system and the second node of the cellular communications system, based on the first time (T₁), the third time (T₃), and the fourth time (T₄). In one embodiment, the method is applied for URLLC traffic. In another embodiment, the method is applied for real-time traffic. In one embodiment, the method is applied for RTP traffic over UDP.

In one embodiment, a time difference between a time (T′₂) at which the packet observed at the third time (T₃) was sent in the second direction of the communication path and a reference time (T′₀) of a respective one of the first and second nodes that sent the packet is encoded in a time at which the respective one of the first and second nodes sent the packet observed at the fourth time (T₄). In one embodiment, the time at which the respective one of the first and second nodes sent the packet observed at the fourth time (T₄) is 2*(T′₂−T′₀). In another embodiment, the time at which the respective one of the first and second nodes sent the packet observed at the fourth time (T₄) is f*(T′₂−T′₀), where f is a predefined or configured factor that is greater than 0 and less than 1.

In one embodiment, computing the one-way latency for the first direction of the communication path between the first node of the cellular communications system and the second node of the cellular communications system comprises computing the one-way latency as Δ+T₄−T₃−T₁, where Δ is a time difference between a clock of the observation function and a clock of the respective one of the first and second nodes that sent the packet observed at the fourth time (T₄). In one embodiment, the time difference (Δ) is known to the observation function such that the one-way latency for the first direction of the communication path is an explicit one-way latency value. In another embodiment, the time difference (Δ) is unknown to the observation function such that the one-way latency for the first direction of the communication path is a relative one-way latency value based on a difference of an actual one-way latency value computed for the first direction of the communication path and a previous actual one-way latency value computed for the first direction of the communication path for a previous measurement cycle.

In one embodiment, the method further comprises computing a one-way latency for the second direction of the communication path between the first node of the cellular communications system and the second node of the cellular communications system based on the third time (T₃) and the fourth time (T₄). In one embodiment, the one-way latency for the second direction of the communication path is computed as 2T₃−T₄−Δ, where Δ is a time difference between a clock of the observation function and a clock of the respective one of the first and second nodes that sent the packet observed at the fourth time (T₄). In one embodiment, the time difference (Δ) is known to the observation function such that the one-way latency for the second direction of the communication path is an explicit one-way latency value. In another embodiment, the time difference (Δ) is unknown to the observation function such that the one-way latency for the second direction of the communication path is a relative one-way latency value based on a difference of an actual one-way latency value computed for the second direction of the communication path and a previous actual one-way latency value computed for the second direction of the communication path for a previous measurement cycle.

In one embodiment, the first node is a UE, and the second node is a base station. In another embodiment, the first direction of the communication path is an uplink direction, and the second direction of the communication path is a downlink direction. In one embodiment, the observation function is implemented at the UE.

In one embodiment, the first node is a base station, and the second node is a UE. In one embodiment, the first direction of the communication path is a downlink direction, and the second direction of the communication path is an uplink direction. In one embodiment, the observation function is implemented at the base station. In one embodiment, the first latency spin bit and the second latency spin bit are comprised in a PDCP header or an extension of a PDCP header. In another embodiment, the first latency spin bit and the second latency spin bit are comprised in a SDAP header or an extension of a SDAP header.

In one embodiment, the first node is a base station, and the second node is a core network node. In one embodiment, the core network node is a UPF. In one embodiment, the observation function is implemented at the base station. In another embodiment, the first node is a core network node, and the second node is a base station. In one embodiment, the core network node is a UPF. In one embodiment, the observation function is implemented at the base station. In one embodiment, the first latency spin bit and the second latency spin bit are comprised in a GTP header or an extension of a GTP header.

Corresponding embodiments of a network node that implements an observation function are also disclosed. In one embodiment, a network node is adapted to perform the method of operation of the observation in accordance with any of the embodiments described herein.

In one embodiment, a network node comprises processing circuitry configured to cause the network node to observe, at a first time in a first direction of a communication path between a first node of a cellular communications system and a second node of the cellular communications system, a packet with a first latency spin bit set to a first value and store the first time. The processing circuitry is further configured to cause the network node to observe, at a second time in the first direction of the communication path between the first node of the cellular communications system and the second node of the cellular communications system, a packet with the first latency spin bit set to a second value and store the second time. The processing circuitry is further configured to cause the network node to compute a RTT for communication between the first node and the second node as a difference of the second time and the first time. The first latency spin bit is comprised in each of the packets at or above a PDCP layer in a defined protocol stack of the cellular communications system.

In one embodiment, a base station comprises processing configured to cause the base station to observe, at a first time in a first direction of a communication path between a UE of a cellular communications system and the base station, a packet with a first latency spin bit set to a first value and store the first time. The processing circuitry is further configured to cause the base station to observe, at a second time in the first direction of the communication path between the UE and the base station, a packet with the first latency spin bit set to a second value and store the second time. The processing circuitry is further configured to cause the base station to compute a first RTT for communication between the UE and the base station as a difference of the second time and the first time. The processing circuitry is further configured to cause the base station to observe, at a third time in a first direction of a communication path between the base station and a core network node of the cellular communications system, a packet with a first latency spin bit set to a first value and store the third time. The processing circuitry is further configured to cause the base station to observe, at a fourth time in the first direction of the communication path between the base station and the core network node, a packet with the first latency spin bit set to a second value and store the fourth time. The processing circuitry is further configured to cause the base station to compute a second RTT for communication between the base station and the core network node as a difference of the fourth time and the third time. The first latency spin bit comprised in each of the packets in the communication path between the UE and the base station is comprised at a PDCP layer or SDAP layer in a defined protocol stack for communication between the UE and the base station. The first latency spin bit comprised in each of the packets in the communication path between the base station and the core network node is comprised in a GTP layer of a defined protocol stack for communication between the base station and the core network node.

Embodiments of a method performed by a first node of a cellular communications system are also disclosed. In one embodiment, a method performed by a first node of a cellular communications system comprises sending a packet with a first latency spin bit set to a first value to a second node of the cellular communications system, receiving a packet with the first latency spin bit set to the first value from the second node, toggling the first latency spin bit to a second value responsive to receiving the packet with the first latency spin bit set to the first value from the second node. The method further comprises sending a packet with the first latency spin bit set to the second value to the second node and receiving a packet with the first latency spin bit set to the second value from the second node. The first latency spin bit is comprised in the packet at or above a PDCP layer in a defined protocol stack of the cellular communications system.

In one embodiment, a RTT between the first node and the second node is computed as a difference of: (a) a time at which the packet with the first latency spin bit value set to the second value sent from the first node to the second node is observed at an observation point in a communication path between the first node to the second node and (b) a time at which the packet with the first latency spin bit value set to the first value sent from the first node to the second node is observed at the observation point in the communication path between the first node to the second node. In another embodiment, a RTT between the first node and the second node is computed as a difference of: (i) a time at which the packet with the first latency spin bit value set to the second value sent from the second node to the first node is observed at the observation point in the communication path between the first node to the second node and (b) a time at which the packet with the first latency spin bit value set to the first value sent from the second node to the first node is observed at the observation point in the communication path between the first node to the second node. In one embodiment, the observation point is at the first node, and the method further comprises computing the round-trip time between the first node and the second node.

In one embodiment, the first node is a UE, and the second node is a base station. In another embodiment, the first node is a base station, and the second node is a UE. In one embodiment, the first latency spin bit is comprised in a PDCP header or an extension of a PDCP header. In another embodiment, the first latency spin bit is comprised in a SDAP header or an extension of a SDAP header.

In one embodiment, the first node is a base station, and the second node is a core network node. In another embodiment, the first node is a core network node, and the second node is a base station. In one embodiment, the core network node is a UPF. In one embodiment, the first latency spin bit is comprised in a GTP header or an extension of a GTP header.

In one embodiment, the packet with the first latency spin bit set to the first value is received from the second node at a first time (T₁), and the method further comprises receiving, at a third time (T₃), a packet that includes the first latency spin bit set to the second value that was sent by the second node at a second time (T′₂) and storing the third time (T₃). The method further comprises receiving, at a fourth time (T₄) from the second node, a packet that includes a second latency spin bit that has been toggled and storing the fourth time (T₄). The method further comprises computing a one-way latency for a first direction of a communication path between the first node and the second node, based on the first time (T₁), the third time (T₃), and the fourth time (T₄). In one embodiment, a time difference between the time (T′₂) at which the packet received at the third time (T₃) was sent by the second node and a reference time (T′₀) at the second node is encoded in a time at which the second node sent the packet received at the fourth time (T₄). In one embodiment, the time at which the second node sent the packet received at the fourth time (T₄) is 2*(T′₂−T′₀). In another embodiment, the time at which the second node sent the packet received at the fourth time (T₄) is f*(T′₂−T′₀), where f is a predefined or configured factor that is greater than 0 and less than 1.

In one embodiment, computing the one-way latency for the first direction of a communication path between the first node and the second node comprises computing the one-way latency as Δ+T₄−T₃−T₁, where Δ is a time difference between a clock of the first node and a clock of the second node. In one embodiment, the time difference (Δ) is known to the first node such that the one-way latency is an explicit one-way latency value. In another embodiment, the time difference (Δ) is unknown to the first node such that the one-way latency is a relative one-way latency value based on a difference of an actual one-way latency value computed for the first direction of the communication path and a previous actual one-way latency value computed for the first direction of the communication path for a previous measurement cycle.

In one embodiment, the method further comprises computing a one-way latency for a second direction of the communication path between the first node and the second node based on the third time (T₃) and the fourth time (T₄). In one embodiment, the one-way latency for the second direction of the communication path is computed as 2T₃−T₄−Δ, where Δ is a time difference between a clock of the first node and a clock of the second node. In one embodiment, the time difference (Δ) is known to the first node such that the one-way latency for the second direction of the communication path is an explicit one-way latency value. In another embodiment, the time difference (Δ) is unknown to the first node such that the one-way latency for the second direction of the communication path is a relative one-way latency value based on a difference of an actual one-way latency value computed for the second direction of the communication path and a previous actual one-way latency value computed for the second direction of the communication path for a previous measurement cycle.

In one embodiment, the first node is a UE, and the second node is a base station. In another embodiment, the first node is a base station, and the second node is a UE. In one embodiment, the first latency spin bit and the second latency spin bit are comprised in a PDCP header or an extension of a PDCP header. In another embodiment, the first latency spin bit and the second latency spin bit are comprised in a SDAP header or an extension of a SDAP header.

In one embodiment, the first node is a base station, and the second node is a core network node. In another embodiment, the first node is a core network node, and the second node is a base station. In one embodiment, the core network node is a UPF. In one embodiment, the first latency spin bit and the second latency spin bit are comprised in a GTP header or an extension of a GTP header.

Corresponding embodiments of a first node for a cellular communications system are also disclosed. In one embodiment, a first node for a cellular communications system is adapted to perform a method of operation thereof in accordance with any of the embodiments described herein.

In one embodiment, a first node for a cellular communications system comprises processing circuitry configured to cause the first node to send a packet with a first latency spin bit set to a first value to a second node of the cellular communications system, receive a packet with the first latency spin bit set to the first value from the second node, and toggle the first latency spin bit to a second value responsive to receiving the packet with the first latency spin bit set to the first value from the second node. The processing circuitry is further configured to cause the first node to send a packet with the first latency spin bit set to the second value to the second node and receive a packet with the first latency spin bit set to the second value from the second node. The first latency spin bit is comprised in the packet at or above a PDCP layer in a defined protocol stack of the cellular communications system.

Embodiments of a method performed by a second node of a cellular communications system are also disclosed. In one embodiment, a method performed by a second node of a cellular communications system comprises receiving, at a time T′₂, a packet with a first latency spin bit that has been toggled from a first value to a second value from a first node of the cellular communications system. The method further comprises, in response to receiving the packet with the first latency spin bit that has been toggled, sending a packet with the first latency spin bit set to the second value to the first node, toggling a second latency spin bit, and sending, at a time that encodes T′₂−T′₀, a packet with a second latency spin bit that has been toggled from a first value to a second value, where T′₀ is a reference time at the second node. The first latency spin bit and the second latency spin bit are each comprised in the respective packet at or above a PDCP layer in a defined protocol stack of the cellular communications system.

In one embodiment, the time that encodes T′₂−T′₀ is a time 2*(T′₂−T′₀). In another embodiment, the time that encodes T′₂−T′₀ is a time f*(T′₂−T′₀), where f is a predefined or configured factor that is greater than 0 and less than 1.

Corresponding embodiments of a second node for a cellular communications system are also disclosed. In one embodiment, a second node for a cellular communications system is adapted to perform the method of operation thereof in accordance with any of the embodiments described herein.

In one embodiment, a second node for a cellular communications system comprises processing circuitry configured to cause the second node to receive, at a time T′₂, a packet with a first latency spin bit that has been toggled from a first value to a second value from a first node of the cellular communications system. The processing circuitry is further configured to cause the second node to, in response to receiving the packet with the first latency spin bit that has been toggled, send a packet with the first latency spin bit set to the second value to the first node, toggle a second latency spin bit, and send, at a time that encodes T′₂−T′₀, a packet with a second latency spin bit that has been toggled from a first value to a second value, where T′₀ is a reference time at the second node. The first latency spin bit and the second latency spin bit are each comprised in the respective packet at or above a PDCP layer in a defined protocol stack of the cellular communications system.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of passive latency monitoring enabled by QUIC;

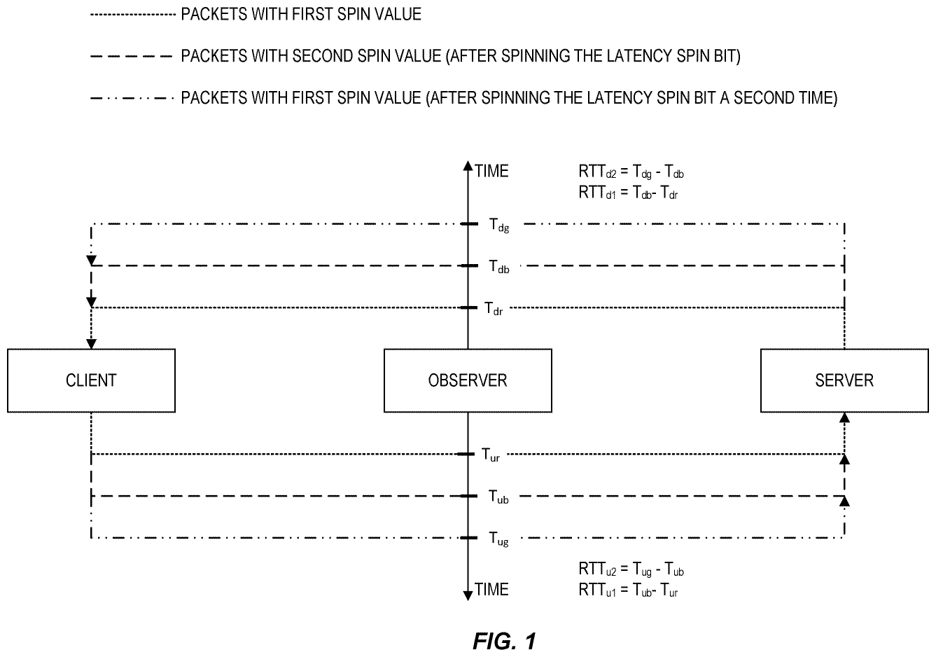

FIG. 2 illustrates one example of a cellular communications system according to some embodiments of the present disclosure;

FIGS. 3 and 4 illustrate example embodiments in which the cellular communication system of FIG. 2 is a Fifth Generation (5G) System (5GS);

FIG. 5 illustrates the protocol stack for the 5GS;

FIG. 6 illustrates a system for estimating Round-Trip Time (RTT) or both RTT and one-way latency between two nodes in a cellular communications system using latency spin bits, in accordance with one embodiment of the present disclosure;

FIG. 7 illustrates an example embodiment of the system of FIG. 6 in which the first node is a User Equipment (UE) and the second node is a base station (i.e., a New Radio (NR) base station or gNB in the illustrated example);

FIG. 8 illustrates the operation of the UE and gNB of FIG. 7 in accordance with one embodiment of the present disclosure;

FIG. 9 illustrates another example embodiment of the system of FIG. 6 in which the first node is a base station (i.e., a gNB in the illustrated example) and the second node is a User Plane Function (UPF);

FIG. 10 illustrates the operation of the gNB and the UPF of FIG. 9 in accordance with one embodiment of the present disclosure;

FIG. 11 illustrates an example embodiment in which the UE-Radio Access Network (RAN) RTT measurement(s) of FIGS. 7 and 8 and the RAN-UPF RTT measurement(s) of FIGS. 9 and 10 are combined;

FIG. 12 illustrates the operation of the system 600 to perform a procedure for determining a one-way latency using both a first latency spin bit and a second latency spin bit in accordance with one example embodiment of the present disclosure.

FIG. 13 illustrates a procedure that is the same as that of FIG. 12 other than the time stamp encoded in step 1310 is less than that in step 1210 such that the procedure is performed in an accelerated way as compared to that of FIG. 12, in accordance with one embodiment of the present disclosure;

FIG. 16 illustrates the Packet Data Convergence Protocol (PDCP) Data Protocol Data Unit (PDU) Format with 12 bits PDCP Sequence Number defined in current 3^{rd} Generation Partnership Project (3GPP) specifications;

FIG. 17 illustrates the PDCP Data PDU Format for Data Radio Bearers (DRBs) with 8 bits PDCP Sequence Number as defined in current 3GPP specifications;

FIG. 18 illustrates a Generic Packet Radio Service (GPRS) Tunneling Protocol (GTP) header as defined in current 3GPP specifications;

FIG. 19 is a schematic block diagram of a network node according to some embodiments of the present disclosure;

FIG. 20 is a schematic block diagram that illustrates a virtualized embodiment of the network node of FIG. 19 according to some embodiments of the present disclosure;

FIG. 21 is a schematic block diagram of the network node of FIG. 19 according to some other embodiments of the present disclosure;

FIG. 22 is a schematic block diagram of a UE according to some embodiments of the present disclosure; and

FIG. 23 is a schematic block diagram of the UE of FIG. 22 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Certain problems exist with existing cellular communication system technology. Telecommunication operators are often interested in what latency contribution their network is given to the end-to-end latency. This is especially important for new Ultra-Reliable Low-Latency Communication (URLLC) traffic types, which will be more common in 5G mobile networks. Due to potential segmentation of a data unit entering the NG-RAN and/or the representation of a single or a few statistical measurement values, current metrics may not be good enough for this case. Further, the QUIC latency spin bit may provide an estimate of the end-to-end RTT which is good; however, it is only applicable to the QUIC protocol. Embodiments of the present disclosure aim to solve this problem and provide the operators a simpler and more accurate estimate of the latency contribution their network has to the end-to-end latency.

A further problem is that obtaining end-to-end latency based on core network and radio network statistical counters is difficult or impossible due to the aggregated nature of the statistical data. Namely, it is usually not possible to derive the distribution of end-to-end delay from distributions in core network delay and that of the radio domain.

Further, RTT is not a good measure of end-to-end latency if uplink and downlink delays are asymmetric. Uplink and downlink delay separation would be especially important for mobile networks. Uplink and downlink radio solutions are different. For example, uplink radio is oftentimes power limited (e.g., maximum transmission power of UEs is 23-26 dBm). In case of delay issues, it should be possible to identify whether the delay issue is in the downlink path or the uplink path. RTT as measured KPI is insufficient for this purpose.

UEs and radio and transport nodes are not fully time synchronized. Therefore, uplink and downlink delays are not possible to obtain, e.g. based on time stamps of messages.

Systems and methods are disclosed herein that address the aforementioned and/or other problems with existing technology. In particular, systems and methods are disclosed herein for determining RTT and/or the one-way latency (e.g., uplink latency or downlink latency) between a UE and a base station (e.g., gNB) and/or between two network nodes (e.g., a base station such as, e.g., a gNB and a core network node such as, e.g., a UPF) using latency spin bits. The following description focuses on embodiments implemented in a 5GS and, as such, 5GS terminology is oftentimes used. However, the solutions described herein are not limited to the 5GS and may be utilized in other types of wireless systems or cellular communications systems such as, e.g., an Evolved Packet System (EPS) or a 6^{th} Generation (6G) system.

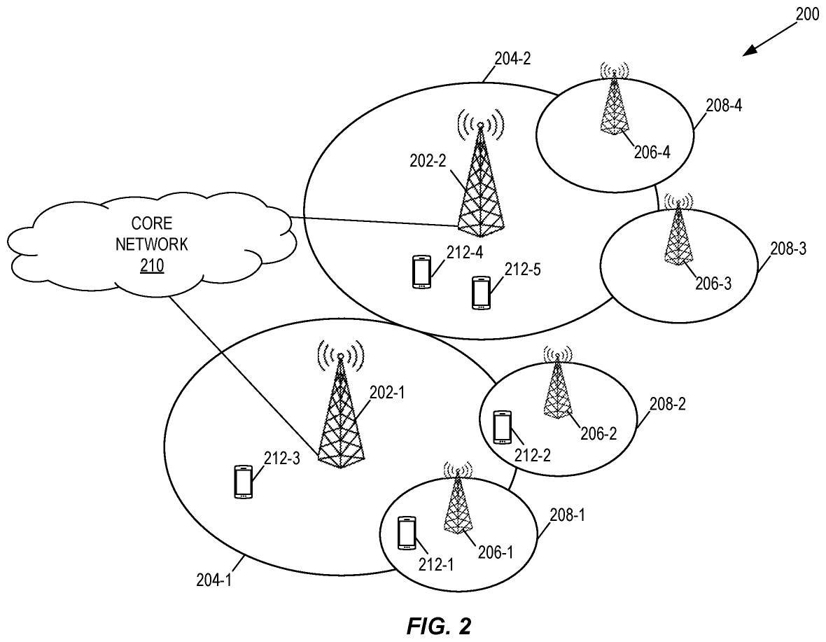

FIG. 2 illustrates one example of a cellular communications system 200 in which embodiments of the present disclosure may be implemented. In the embodiments described herein, the cellular communications system 200 is a 5GS including a Next Generation RAN (NG-RAN) and a 5G Core (5GC); however, the solutions described herein are not limited to the 5GS. In this example, the RAN includes base stations 202-1 and 202-2, which in the 5GS include NR base stations (gNBs) and optionally next generation eNBs (ng-eNBs) (e.g., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs and as such sometimes referred to herein as UEs 212, but the present disclosure is not limited thereto.

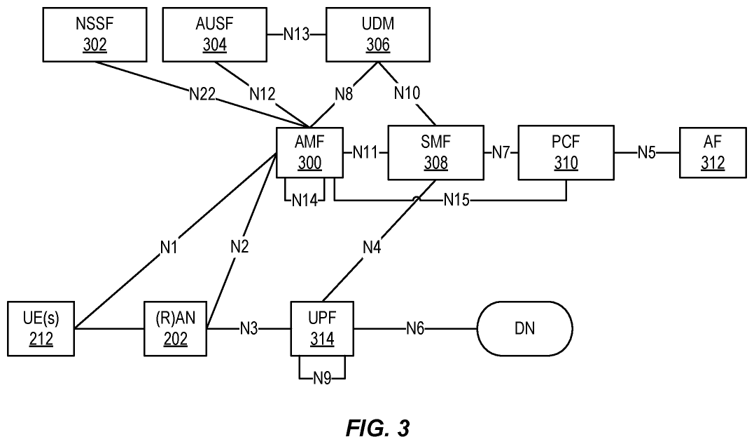

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R (AN) 202 comprises base stations, e.g. such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFS through the service-based interface. In FIG. 4 the service based interfaces are indicated by the letter “N” followed by the name of the NF, e.g. Namf for the service based interface of the AMF 300 and Nsmf for the service based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

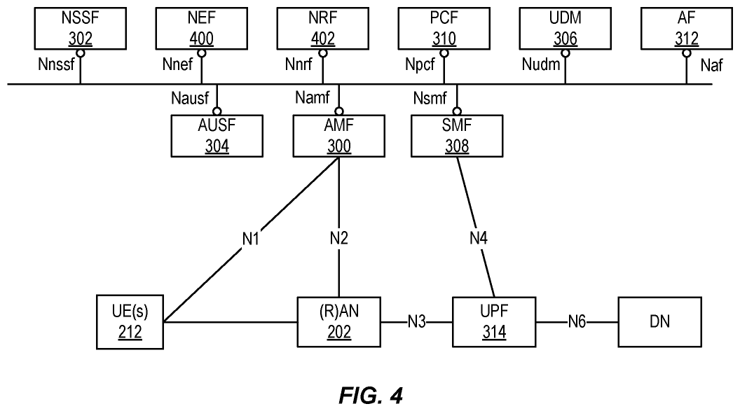

FIG. 5 illustrates the protocol stack for the 5GS. Segmentation of data units may be done in the protocol layers below the Packet Data Convergence Protocol (PDCP) layer. Hence, in the NG-RAN, the PDCP protocol is the layer in which the data unit, such as an Internet Protocol (IP) packet or an Ethernet Protocol Data Unit (PDU), is non-segmented.

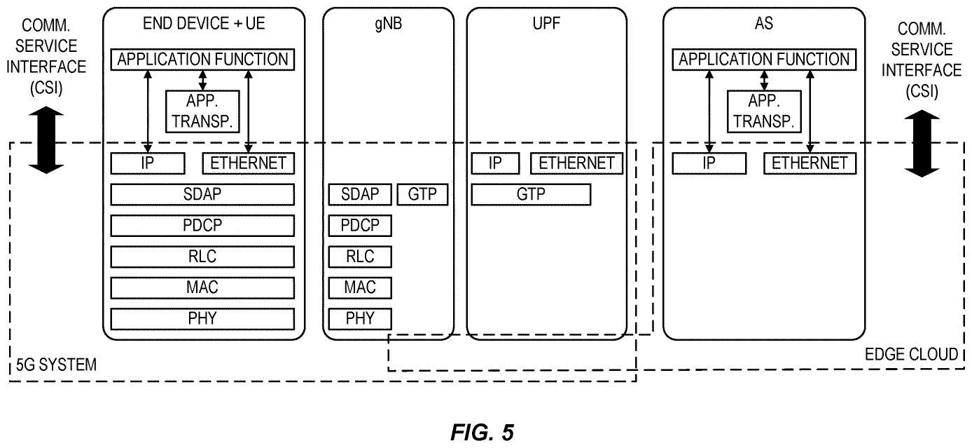

FIG. 6 illustrates a system 600 for estimating RTT or both RTT and one-way latency between two nodes 602-1 and 602-2 in the cellular communications system 200 using latency spin bits, in accordance with one embodiment of the present disclosure. In one embodiment, the first node 602-1 is a UE 212, and the second node 602-2 is a base station 202 (e.g., gNB). In another embodiment, the first node 602-1 is a base station 202 (e.g., gNB), and the second node 602-2 is a core network node (e.g., UPF) in the core network 210. The first node 602-1 includes a client function 604, and the second node 602-2 includes a server function 606. In yet another embodiment, the first node 602-1 is a UE 212 and the second node 602-2 is a core network node (e.g., a UPF), where the UE 212 and the core network communicate via one or more additional network nodes (node shown) including a base station 202 (e.g., a gNB). The system 600 also includes an observation function 608 that, in the illustrated example, is implemented at the second network node 602-2. However, the observation function 608 may be implemented at any point in the communication path between the first node 602-1 and the second node 602-2.

As described below in detail, the observation function 608 observes a first latency spin bit for measurement of the RTT between the first node 602-1 and the second node 602-2 and, in some embodiments, a second latency spin bit for measurement of a one-way latency (e.g., uplink latency, downlink latency, or both uplink latency and downlink latency) between the first node 602-1 and the second node 602-2. The first and second latency spin bits are communicated, and thus the observation function 608 operates, at or above the PDCP layer (e.g., at the PDCP layer or at the Service Data Adaptation Protocol (SDAP) layer for UE-gNB RTT or UE-gNB one-way latency or at the GTP layer for gNB-UPF RTT or gNB-UPF one-way latency) in order to have a good and accurate estimate of latency contribution of the NG-RAN part to the data unit sent via the 5GS.

In one embodiment, the first node 602-1 is a UE 212, the second node 602-2 is a base station 202 (i.e., a gNB in this example), and the first latency spin bit is utilized in the PDCP layer (see, e.g., 3GPP TS 38.323) or SDAP layer (see, e.g., 3GPP TS 37.324) to determine the UE-gNB 1-RTT latency in a manner similar to how the latency spin bit is used in the QUIC protocol. In one embodiment, the first latency spin bit is included in the PDCP or SDAP packet header (e.g., using a previously used, or reserved, bit or using a new bit). In another embodiment, the first node 602-1 is a base station 202 (i.e., a gNB in this example), the second node 602-2 is a core network node (i.e., a UPF in this example), and the first latency spin bit is utilized in the General Packet Radio Service (GPRS) Tunneling Protocol (GTP) to determine the gNB-UPF 1-RTT latency in a manner similar to how the latency spin bit is used in the QUIC protocol. In one embodiment, the first latency spin bit is included in the GTP packet header (e.g., using a previously used, or reserved, bit or using a new bit).

In one embodiment, in addition to the first latency spin bit, a second latency spin bit is used to determine a one-way latency (e.g., downlink latency, uplink latency, or both the downlink latency and the uplink latency) between the first node 602-1 and the second node 602-2. As described below in detail, the one-way latency is determined by having the server 606 spin the second latency spin bit a certain (e.g., predetermined or configured) amount of time after the server 606 has seen that the first latency spin bit has been spun (i.e., toggled) by the client 604 in the data flow. The observation function 608 then estimates, via observation of the first and second latency spin bits, the one-way latency.

More specifically, in one embodiment, the first latency spin bit is used for obtaining the RTT, and the second latency spin bit is used to encode a time of receiving the spun (e.g., toggled) first latency spin bit at the server 606 and transfer this encoded information to the observation function 608. The uplink delay and the downlink delay are calculated at the observation function 608 by measuring a time difference between observing the spinning (e.g., toggling) of the first latency spin bit and observing the spinning (e.g., toggling) of the second latency spin bit. Further, in one embodiment, if a time shift between the clocks of the observation function 608 and server 606 is known (e.g., available from separate information or protocol) or the two clocks are synchronized, the uplink delay and the downlink delay can be explicitly calculated. However, if this time shift is unavailable, in one embodiment, the RTT is monitored (e.g., periodically or continuously) based on the first latency spin bit. If the RTT increases (e.g., by more than a predefined or configured amount), an extra delay in the uplink or downlink is determined by observing the arriving time of two consecutive first and second latency spin bit flips.

Embodiments of an accelerated operation for determining the one-way latency are also disclosed. In one embodiment, a predefined fraction of an arriving time of spun (e.g., toggled) first latency spin bit is encoded in a delay of spinning (e.g., toggling) the second latency spin bit at the server. This fraction can be e.g., ⅕, 1/10, or 1/20. By using a fraction, rather than a multiple, of the arriving time of the spun first latency spin bit, the measurement cycle for the one-way latency is accelerated and the probability of the channel conditions changing during the measurement cycle is decreased.

Embodiments are disclosed that enable RTT measurement via a first latency spin bit in the PDCP or GTP header using currently reserved or free bits or using extension headers.

Embodiments are disclosed that enable one-way latency measurement by utilizing a first latency spin bit and a second latency spin bit (e.g., in the QUIC, PDCP and/or GTP header). The first and second latency spin bits may use currently reserved or free bits in the existing header(s) or use extension headers. In one embodiment, the server node instead of the client node spins the second latency spin bit at a given time after the server has noticed that the first spin bit has changed value, thereby encoding timing information that can be used to determine the one-way latency.

In one embodiment, the second latency spin bit flip is used for encoding a time, or a fraction of a time, when first latency spin bit flip is received and sending this information to the observer.

It should be noted that the methods disclosed herein for determining RTT and one-way latency may be applied for Ultra-Reliable Low Latency Communication (URLLC) traffic, real time traffic, Real Time Protocol (RTP) over UDP, or the like.

Further details of the aforementioned and other embodiments of the present disclosure will now be described in the following subsections. Note that the embodiments described in the following subsections may be used separately or in any desired combination.

### 1 RTT and One-Way Latency Establishment Using a First and a Second Spin Bit in the Cellular System Protocol Layer and QUIC

As discussed above, FIG. 5 illustrates the 5GS protocol stack. Segmentation of data units may be done in the protocol layers below the PDCP protocol. Hence, in RAN the PDCP protocol is the layer in which the data unit, such as an IP-packet or an Ethernet PDU, is non-segmented. Thus, as described above, the observation function 608 is placed at or above the PDCP layer in order to have a good and accurate estimate of latency contribution of the RAN part to the data unit sent via the 5GS.

1.1 Establishing RTT Measurement with a First Latency Spin Bit

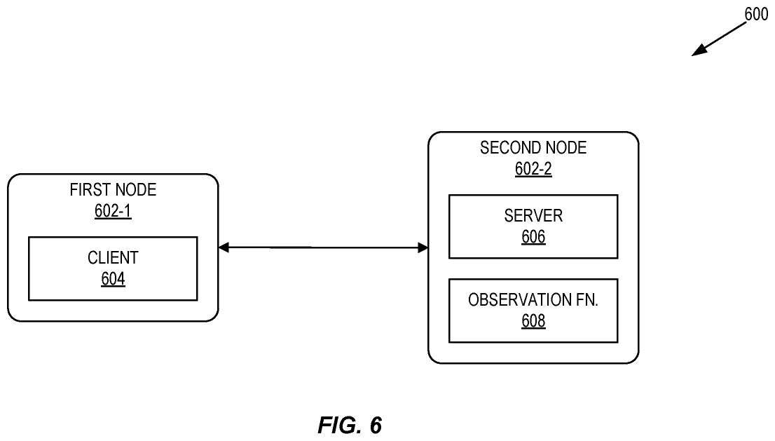

FIG. 7 illustrates an example embodiment of the system 600 in which the first node 602-1 is a UE 212, and the second node 602-2 is a base station 212 which in this example is a gNB (denoted here as gNB 212). In this embodiment, a first latency spin bit is used in the PDCP or SDAP layer for gNB-UE RTT latency (i.e., RAN RTT) measurement. As shown, in this example, the client 604 is at the UE 212, and both the server 606 and the observation function 608 are at the gNB 212.

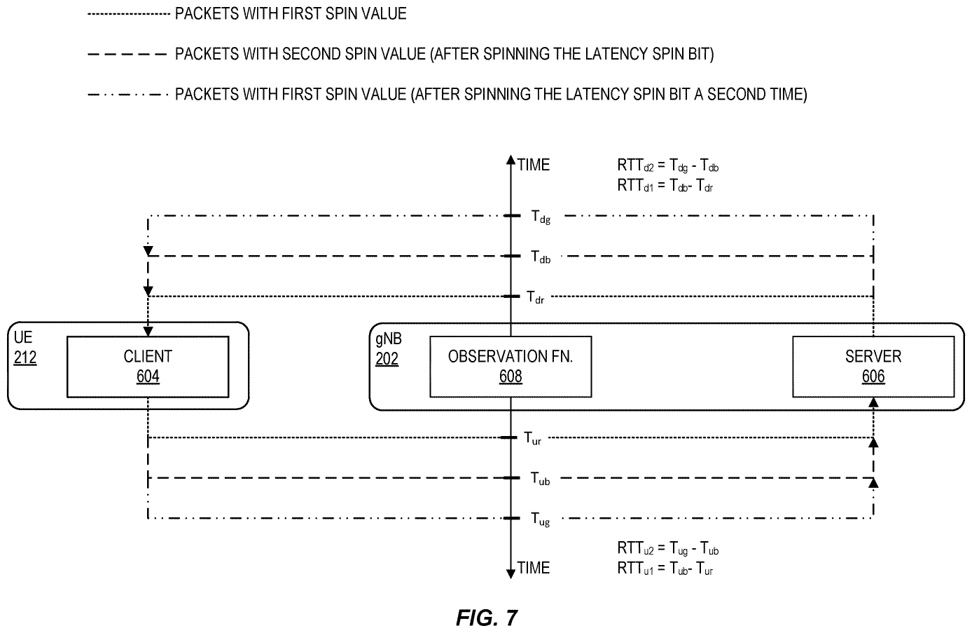

FIG. 8 illustrates the operation of the UE 212 and gNB 202 of FIG. 7 in accordance with one embodiment of the present disclosure. Optional steps are represented by dashed lines/boxes. As illustrated, the client 604 at the UE 212 sends, to the gNB 202, a packet (e.g., a PDCP packet or SDAP packet) with a first latency spin bit set to a first latency spin bit value, e.g., in a PDCP or SDAP header of the packet (step 800). The observation function 608 stores a time, Tᵤᵣ, at which the observation function 608 observes the packet with the first latency spin bit set to the first latency spin bit value (step 802). In this example, the observation function 608 is implemented at the gNB 202 and, as such, the time, Tᵤᵣ, is the time at which the packet with the first latency spin bit set to the first value is received at the gNB 202 on the uplink from the UE 212. The server 606 at the gNB 202 sends a packet that reflects (e.g., includes) the first latency spin bit set to the first value to the UE 212 (step 804) and stores a time, Tar, at which the observation function 708 observes the packet that reflects the first latency spin bit set to the first value on the downlink to the UE 212 (step 806). In this example, the observation function 608 is implemented at the gNB 202 and, as such, the time, Tar, is the time at which the packet that reflects the first latency spin bit set to the first value is transmitted from the gNB 202 to the UE 212 on the downlink.

At the UE 212, the client 704 spins (e.g., toggles) the first latency spin bit to a second latency spin bit value (step 808) and transmits, to the gNB 212, a packet with the first latency spin bit set to the second latency spin bit value (step 810). Note that, for PDCP, the client function 604 may spin (e.g., toggle) the first latency spin bit from the packet at the head, or start, of the PDCP queue or alternatively the packet at the tail, or end, of the PDCP queue. Similarly, the server function 606 will reflect the first latency spin bit starting from the head or tail of the PDCP queue. The observation function 708 observes the packet with the first latency spin bit set to the second value and stores a time, T_{ub}, at which this packet is observed (step 812). The server 606 at the gNB 202 sends a packet that reflects (e.g., includes) the first latency spin bit set to the second value to the UE 212 (step 814) and stores a time, T_{db}, at which the observation function 708 observes the packet that reflects the first latency spin bit set to the second value on the downlink to the UE 212 (step 816).

At the UE 212, the client 704 spins (e.g., toggles) the first latency spin bit back to the latency spin bit value (step 818) and transmits, to the gNB 212, a packet with the first latency spin bit set to the first latency spin bit value (step 820). The observation function 708 observes the packet with the first latency spin bit set to the first value and stores a time, T_{ug}, at which this packet is observed (step 822). The server 606 at the gNB 202 sends a packet that reflects (e.g., includes) the first latency spin bit set to the first value to the UE 212 (step 824) and stores a time, T_{dg}, at which the observation function 708 observes the packet that reflects the first latency spin bit set to the first value on the downlink to the UE 212 (step 826).

The observation function 708 then computes one or more RTT values, or measurements, for the RTT between the UE 212 and the gNB 202 based on the stored time values (step 828). For example, the observation function 708 may compute any one or more of the following RTT values:

$${RTT}_{u 1} = {T}_{ub} - {T}_{ur}$$

$${RTT}_{u 2} = {T}_{ug} - {T}_{ub}$$

$${RTT}_{d 1} = {T}_{db} - {T}_{dr}$$

$${RTT}_{d 2} = {T}_{dg} - {T}_{db} .$$

Note that, in an alternative embodiment, the observation function 708 may provide the measured time values to another node that then computes the RTT measurement(s) based on those measured time values.

The gNB 202 uses the computed RTT measurement(s) for one or more operational tasks and/or sends the computed RTT measurement(s) to, e.g., another network node (step 830). Examples of the operational task(s) that may include, but are not limited to, allocating more resources to the UE 212 in order to reduce the latency if the RTT is too large (e.g., greater than a predefined or configured threshold RTT), performing some other radio resource action (e.g., admission control) to improve the RTT if the RTT is too large (e.g., greater than a predefined or configured threshold RTT), sending the computed RTT measurement(s) to an analytics system which may, e.g., use the RTT measurement(s) for SLA assurance (e.g., checking if RTT target values are met), aggregate the RTT measurement(s) with those from one or more different end points, radio conditions, or the like to, e.g., identify a root cause if the RTT is too large, or the like.

In the example embodiment of FIG. 8, the observation function 608 observes the packets in steps 800, 804, 810, and 814, stores the times Tᵤᵣ, T_{dr}, T_{ub}, and T_{db}, and computes both RTTᵤ₁=T_{ub}−Tᵤᵣ and RTT_{d1}=T_{db}−T_{dr}. However, the observation function 608 does not necessarily perform all of these steps. For example, the observation function 608 may observe the packets in steps 800 and 810, store Tᵤᵣ and T_{ub}, and compute RTTᵤ₁=T_{ub}−Tᵤᵣ without observing the packets in steps 804 and 814 and/or without storing Tab and Tar and/or without computing RTT_{d1}=T_{db}−T_{dr}, or vice versa.

In one embodiment, the first latency spin bit is included the PDCP or SDAP header of the respective packet. The first latency spin bit value may, for example, use a previously unused, or reserved, bit in the PDCP or SDAP header. Alternatively, a new PDCP or SDAP header format may be defined, where this new PDCP or SDAP header format includes the first latency spin bit. This may be particularly beneficial if the existing PDCP or SDAP header format does not have any available bit to use for the first latency spin bit. Note that, in the case of PDCP, there are three to five reserved bits available in the data PDU that can be used for first latency spin bit depending on the used format of the PDCP sequence number.

In one example alternative embodiment, the packet in which the first latency spin bit is included is a control PDU of either PDCP or SDAP. This could be used as initial empty buffer RTT check. In one embodiment, the procedure of FIG. 8 is performed by a sequence of control PDUs of either PDCP or SDAP.

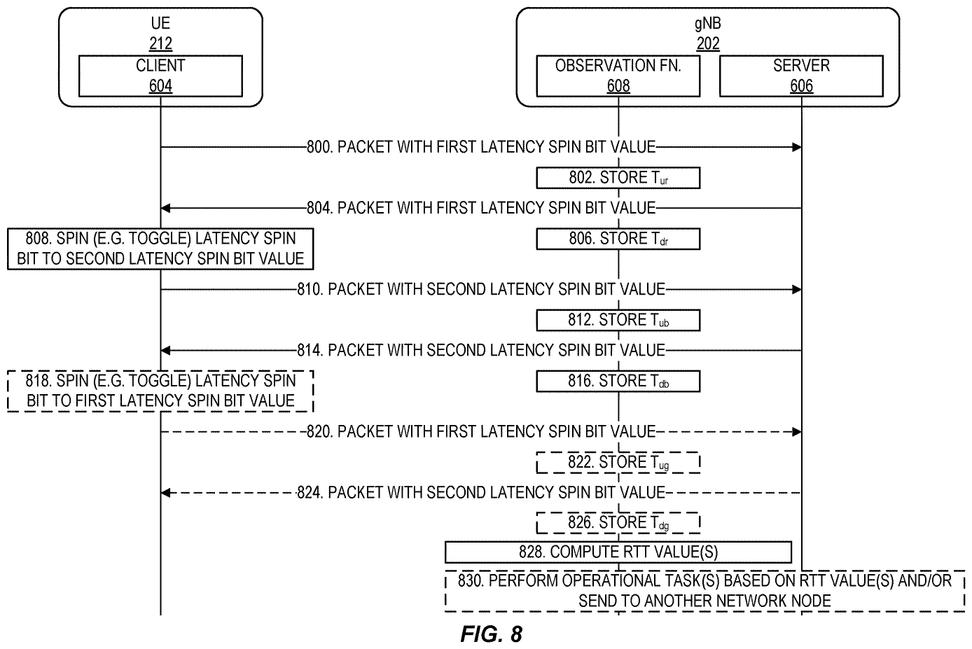

Similar to the embodiment described above in FIGS. 7 and 8, the same approach can be used to establish a RTT latency estimate between the gNB 202 and the UPF 314, e.g., by enabling a first latency spin bit in the GTP protocol (see, e.g., 3GPP TS 29.2891 for details of the existing GTP protocol). In this regard, FIG. 9 illustrates another example embodiment of the system 600 in which the first node 602-1 is a base station 202, which in this particular example is a gNB denoted as “gNB 202”, and the second node 602-1 is the UPF 314. Note that, in an alternative embodiment, the first node 602-1 is the UPF, and the second node 602-2 is the gNB. Further, while in the example of FIG. 9, the observation function 708 is implemented at the UPF 314, the observation function 708 may alternatively be implemented at the gNB 202 or some node between the gNB 202 and the UPF 314.

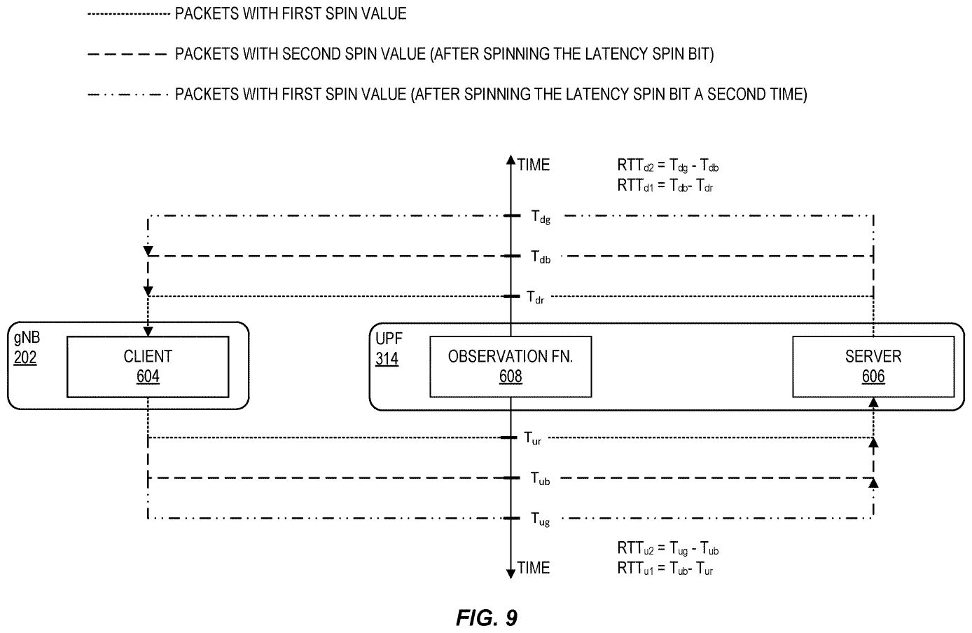

FIG. 10 illustrates the operation of the gNB 202 and the UPF 314 in accordance with one embodiment of the present disclosure. Optional steps are represented by dashed lines/boxes. This process is similar to that of FIG. 8. As illustrated, the client 604 at the gNB 202 sends, to the UPF 314, a packet (e.g., a GTP packet) with a first latency spin bit set to a first latency spin bit value, e.g., in a GTP header of the packet (step 1000). The observation function 608 stores a time, Tᵤᵣ, at which the observation function 608 observes the packet with the first latency spin bit set to the first latency spin bit value (step 1002). In this example, the observation function 608 is implemented at the UPF 314 and, as such, the time, Tᵤᵣ, is the time at which the packet with the first latency spin bit set to the first value is received at the UPF 314 from the gNB 202. The server 606 at the UPF 314 sends a packet that reflects (e.g., includes) the first latency spin bit set to the first value to the gNB 202 (step 1004) and stores a time, Tar, at which the observation function 708 observes the packet that reflects the first latency spin bit set to the first value transmitted from the UPF 314 to the gNB 202 (step 1006). In this example, the observation function 608 is implemented at the UPF 314 and, as such, the time, Tar, is the time at which the packet that reflects the first latency spin bit set to the first value is transmitted from the UPF 314 to the gNB 202.

At the gNB 202, the client 704 spins (e.g., toggles) the first latency spin bit to a second latency spin bit value (step 1008) and transmits, to the UPF 314, a packet with the first latency spin bit set to the second latency spin bit value (step 1010). The observation function 708 observes the packet with the first latency spin bit set to the second value and stores a time, T_{ub}, at which this packet is observed (step 1012). The server 606 at the UPF 314 sends a packet that reflects (e.g., includes) the first latency spin bit set to the second value to the gNB 202 (step 1014) and stores a time, T_{db}, at which the observation function 708 observes the packet that reflects the first latency spin bit set to the second value sent from the UPF 314 to the gNB 202 (step 1016).

At the gNB 202, the client 704 spins (e.g., toggles) the first latency spin bit back to the latency spin bit value (step 1018) and transmits, to the UPF 314, a packet with the first latency spin bit set to the first latency spin bit value (step 1020). The observation function 708 observes the packet with the first latency spin bit set to the first value and stores a time, T_{ug}, at which this packet is observed (step 1022). The server 606 at the UPF 314 sends a packet that reflects (e.g., includes) the first latency spin bit set to the first value to the gNB 202 (step 1024) and stores a time, T_{dg}, at which the observation function 708 observes the packet that reflects the first latency spin bit set to the first value from the UPF 314 to the gNB 202 (step 1026).

The observation function 708 then computes one or more RTT values, or measurements, for the RTT between the gNB 202 and the UPF 314 based on the stored time values (step 1028). For example, the observation function 708 may compute any one or more of the following RTT values:

$${RTT}_{u 1} = {T}_{ub} - {T}_{ur}$$

$${RTT}_{u 2} = {T}_{ug} - {T}_{ub}$$

$${RTT}_{d 1} = {T}_{db} - {T}_{dr}$$

$${RTT}_{d 2} = {T}_{dg} - {T}_{db} .$$

Note that, in an alternative embodiment, the observation function 708 may provide the measured time values to another node that then computes the RTT measurement(s) based on those measured time values.

The UPF 314 uses the computed RTT measurement(s) for one or more operational tasks and/or sends the computed RTT measurement(s) to, e.g., another network node (step 1030). Examples of the operational task(s) that may be performed based on the RTT measurement(s) include, but are not limited to, changing routing to improve the RTT if the RTT is too large (e.g., greater than a predefined or configured threshold RTT), sending the computed RTT measurement(s) to an analytics system (e.g., a Network Data Analytics Function (NWDAF)) which may, e.g., use the RTT measurement(s) for SLA assurance (e.g., checking if RTT target values are met), aggregate the RTT measurement(s) with those from one or more different end points, radio conditions, or the like to, e.g., identify a root cause if the RTT is too large, or the like.

In one embodiment, in the example of FIG. 8, the first latency spin bit is included in the GTP header. In another embodiment, an extension header including the first latency spin value is defined and used.

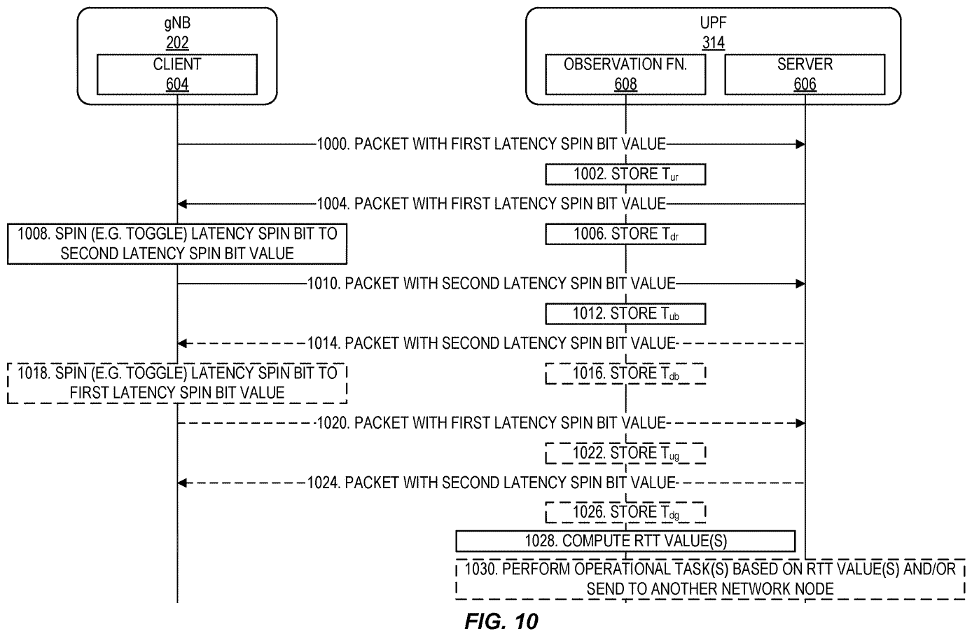

In one embodiment, the UE-RAN RTT measurement(s) of FIGS. 7 and 8 and the RAN-UPF RTT measurement(s) of FIGS. 9 and 10 are combined. In other words, the procedures of FIGS. 8 and 10 are both performed (e.g., by separate observation function 608 located at the same network node (e.g., the base station 202) or separate nodes) to provide the UE-RAN RTT measurement(s) and the RAN-UPF RTT measurement(s). One example of this embodiment is illustrated in FIG. 11. In this embodiment, two spin bit measurement setups (two sets of server/client) are used. This enables 2-segment measurements: one measurement in UE-RAN segment one measurement in RAN-UPF segment. For the UE-RAN segment, the server 706 can be implemented at RAN or gNB 202, the client 704 can be implemented at the UE 212, and the observation function 708 can be implemented at either the RAN (e.g., gNB 202) or the UE 212. For the RAN-UPF segment, the implementation can be either server 706 at the UPF 314 and client 704 at the gNB 202, or the server 706 at gNB 212 and client 706 at the UPF 314. In the RAN-UPF segment, the first latency spin bit can be carried, e.g., in the GTP User Plane (GPT-U) header. Alternatively, if in the future the QUIC protocol is used between the UPF 314 and the gNB 202 (e.g., replacing GTP), the first latency spin bit can be naturally used in the RAN-UPF segment. Further, the UE-RAN RTT measurement using the first latency spin bit in either the PDCP layer or the SDAP layer could be sent to the UPF 314, e.g., within one of the packets or messages sent via the GTP, possibly one of the messages used in the process of FIG. 10. The UPF 314 could combine the RTT measurement of the two system segments into an estimate of the RTT for the whole system (i.e., a UE-UPF RTT measurement).

### 1.2 One-Way Latency Establishment Using a First and a Second Spin Bit in the Cellular System Protocol Layer and QUIC.

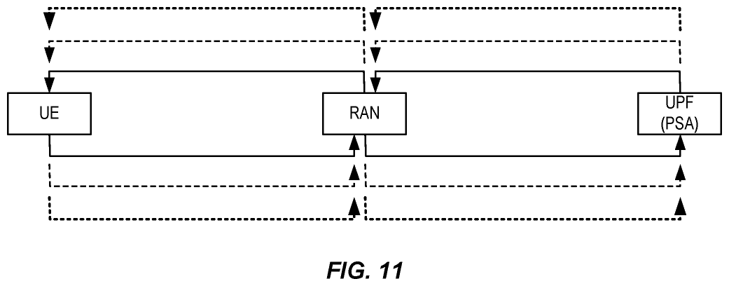

FIG. 12 illustrates the operation of the system 600 to perform a procedure for determining a one-way latency using both a first latency spin bit and a second latency spin bit in accordance with one example embodiment of the present disclosure. Note that, in this example embodiment, the observation function 608 is implemented at the first node 602-1, rather than the second node 602-2 as in the example embodiments described above. In one example embodiment, the first node 602-1 is a UE 212, and the second node 602-2 is a gNB 202. In another example embodiment, the first node 602-1 is a gNB 202, and the second node 602-2 is a UE 212. In yet another embodiment, the first node 602-1 is a gNB 202, and the second node 602-2 is a UPF 314. In yet another embodiment, the first node 602-1 is a UPF 314, and the second node 602-2 is a gNB 202. Optional steps are represented in FIG. 12 by dashed lines/boxes.

In one embodiment, the first node 602-1 and the second node 602-2 are time synchronized or, in other words, the observation function 608 and the server 606 are time synchronized. Thus, the first node 602-1 and the second node 602-2 may have internal timers which are reset (e.g., periodically, e.g., every 1 millisecond (ms) or every 100 ms) at synchronization. For the procedure of FIG. 12, the first node 602-1 has a reference time, T₀, and the second node 602-2 has a reference time, T′₀, where T₀ and T′₀ may be time synchronized or be reset at synchronization. Times at the first node 602-1 are measured from T₀, and times at the second node 602-2 are measured from T′₀. In one example, a common time is used (e.g., Unix time stamps).

Note that restarting the timers used at the first and second nodes 602-1 and 602-2 may also be performed if is no actual synchronization between the first node 602-1 (in particular the observation function 608) and the second node 602-2 in order to keep the encoded delay (see below), i.e. the latency of the measurement, low.

In most practical cases, the system clocks utilized by the first node 602-1 (in particular the observation function 608) and the second node 602-2 are not completely synchronized. The time difference is denoted by Δ. It is assumed that Δ is changing slowly and can be considered constant for the operation of one-way latency estimation.

In the procedure of FIG. 12, a first latency spin bit is used for RTT estimation in the same manner described above with respect to, e.g., FIGS. 7-10. While using the first latency spin bit in this manner, a packet with the first latency spin bit toggled is sent, at time T₁, from the client 604 at the first node 602-1 to the server 606 at the second node 602-2 (step 1200). Note that step 1200 corresponds to step 810 of FIG. 8. Thus, steps analogous to steps 800-808 may be performed prior to step 1200. The observation function 608 observes that the first latency spin bit has been toggled at time T₁ and stores the time T₁ (step 1202). The packet with the first latency spin bit toggled arrives at the server 606 at the second node 602-2 at time T′₂, and the server 606 at the second node 602-2 sends a packet that reflects the same value of the first latency spin bit to the client 604 at the first node 602-1 (step 1204). The packet that reflects the same value of the first latency spin bit arrives at the observation function 608 (and thus the client 604 at the first node 602-1 in this example) at time T₃. The observation function 608 stores the time T₃ (step 1206). RTT can be calculated as RTT=T₃−T₁. In addition, in response to receiving the packet with the first latency spin bit toggled in step 1204, the server 606 toggles a second latency spin bit (step 1208) and sends a packet with the toggled second latency spin bit to the client 604 at a certain time 2(T′₂−T′₀) (step 1210). In this manner, a time stamp of receiving the packet with the first latency spin bit togged at the server 606 is encoded in the delay of sending the packet including the toggled second latency spin bit in step 1210. The packet including the toggled second latency spin bit arrives at the observation function 608 (and thus the client 604 in this example) at time T₄. The observation function 608 stores the time T₄ (step 1212).

The observation function 608 computes a first one-way latency from the observation function 608 (i.e., the first node 602-1 in this example) to the second node 602-2 based on the store times T₄, T₃, and T₁ and, optionally, a second one-way latency from the second node 602-2 to the observation function 608 (i.e., the first node 602-1 in this example) based on the first one-way latency and the RTT (step 1214). More specifically, at the observation function 608, T′₂−T′₀ is estimated as T′₂−T′₀=T₄−T₃, and the first one-way latency (D₁) is defined as:

$${D}_{1} = Δ + {T}_{2}^{′} - {T}_{0}^{′} - {T}_{1} = Δ + {T}_{4} - {T}_{3} - {T}_{1} .$$

Thus, in one embodiment, the first one-way latency (D₁) is calculated at the observation function 608 as:

$${D}_{1} = Δ + {T}_{4} - {T}_{3} - {T}_{1} .$$

The second one-way latency (D₂) can then be calculated by the observation function as:

$${D}_{2} = RTT - {D}_{1} = 2 {T}_{3} - {T}_{4} - Δ .$$

It is assumed that, during this measurement period, the transport channel delay does not change significantly.

The observation function 608 may then perform one or more operational tasks based on the computed one-way latency(s) from step 1214 and/or send the computed one-way latency(s) to another node (e.g., a network node that performs one or more operational tasks based on the computed one-way latency(s)) (step 1216). For example, the one-way latencies may be used to determine whether additional resources need to be made available to the UE 212 in the uplink or downlink or if the downlink or uplink traffic should be allocated to a higher priority Quality of Service (QoS) class, or the like, in order to reduce the respective one-way latency to an acceptable level. Other actions may include, for example, informing another network node of the one-way latencies.

In the embodiment above, Δ (i.e., the clock shift) is known to the observation function 608 (e.g., available from an independent source such as, e.g., a protocol report), and therefore the observation function 608 is able to explicitly calculate both D1 and D2 based on T₁, T₃ and T₄. However, in another embodiment, the observation function 608 does not know A (i.e., the clock shift is unknown). In this case, in step 1214, the observation function 608 may, for example, compute relative one-way latency values for D₁ and D₂ where these values are dependent on the unknown value of A. Further, the observation function 608 or some other network node may compare the first one-way latency values across two (or more) measurement cycles (i.e., the measurement cycle of steps 1200-1212 and a second measurement cycle of steps 1218-1228) to determine whether the one-way latency values are increasing or otherwise changing in an undesired manner and, if so, an appropriate action(s) may be triggered. In the second cycle, the observation function 608 computes either or both of the one-way latency values as a relative value (step 1230). More specifically, a respective value for the first one-way latency (D₁) for the second cycle (denoted here as “D₁(2)” where “(2)” indicates the second cycle) is computed as:

$${D}_{1} ( 2 ) = Δ + {T}_{8} - {T}_{7} - {T}_{5} .$$

Similarly, a respective value for the second one-way latency (D₂) for the second cycle (denoted here as “D₂(2)” where “(2)” indicates the second cycle) is computed as:

$${D}_{2} ( 2 ) = RTT ( 2 ) - {D}_{1} ( 2 ) = 2 {T}_{7} - {T}_{8} - Δ .$$

In one embodiment, the observation function 608 computes relative one-way delay values, i.e., D₁(2)−D₁(1) and/or D₂(2)−D₂(1). Assuming that Δ is constant across the measurement cycles, then the A terms cancel such that:

$${D}_{1} ( 2 ) - {D}_{1} ( 1 ) = {T}_{8} - {T}_{7} - {T}_{5} - {T}_{4} + {T}_{3} + {T}_{1}$$

$$and$$

$${D}_{2} ( 2 ) - {D}_{2} ( 1 ) = ( 2 {T}_{7} - {T}_{8} ) - ( 2 {T}_{3} - {T}_{4} ) .$$

Note that the one-way latency values D₁(1) and D₂(1) are also referred to herein as “actual” one-way latency values for the first measurement cycle, and the one-way latency values D₁(2) and D₂(2) are also referred to herein as “actual” one-way latency values for the second measurement cycle. In contrast, the values D₁(2)−D₁(1) and D₂(2)−D₂(1) are referred to herein as “relative” one-way latency values, where each relative one-way latency value is a value expressed as a difference of the actual one-way delay values for two measurement cycles (e.g., a current measurement cycle and a previous measurement cycle). Once the relative one-way latency values are computed, the observation function 608 may then perform one or more operational tasks based on the relative one-way delay values and/or send the relative one-way delay values to another network node (step 1232).

As an example, in multiple measurement cycles, a typical or average RTT value can be determined by the observation function 608. Assume that due to a transport issue, the first one-way latency (D₁) increases significantly, so D₁(2)>>D₁(1), and the second one-way latency (D₂) is not impacted (e.g., D₂(2)=D₂(1)). RTT(1)=T₃−T₁, RTT(2)=T₇−T₅. Based on the RTT measurements, it is detected that RTT(2)>>RTT(1), so either or both of the first and second one-way delays has increased substantially. If the difference D₁(2)−D₁(1) is much greater than 0 (i.e., greater than a predefined non-zero threshold), then the increased delay is in the first one-way latency. Conversely, if the difference D₁(2)−D₁(1) is nearly 0 (i.e., less than a predefined non-zero threshold) and RTT(2)>>RTT(1), then the increased delay is in the second one-way delay. The observation function 608 or some other network node may utilize the result of this determination to perform one or more operational tasks (e.g., perform one or more operations to reduce the one-way latency that has substantially increased).

### 1.3 Accelerated One-Way Latency Solution

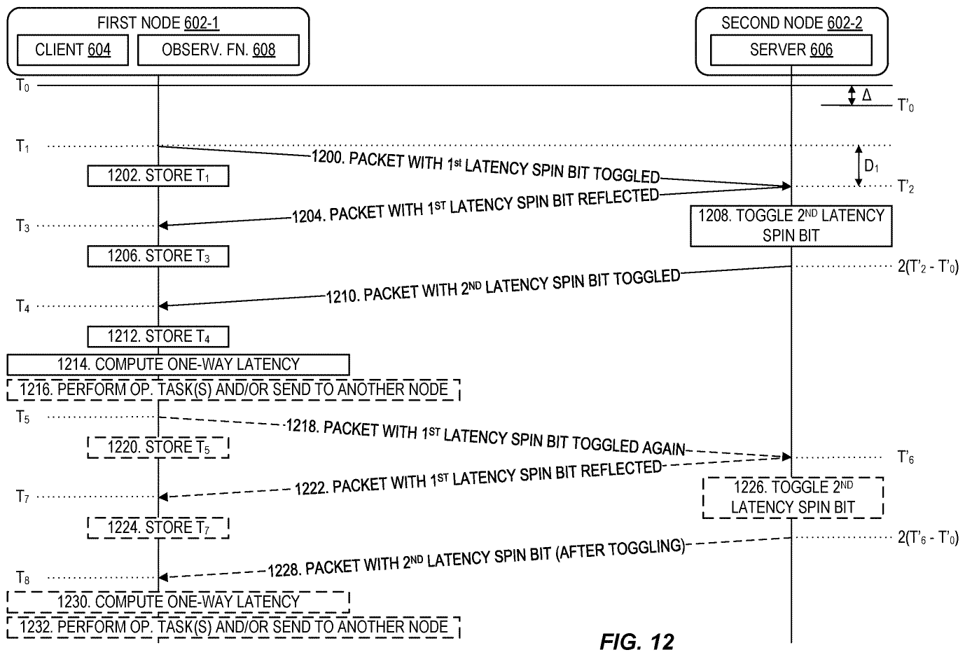

FIG. 13 illustrates a procedure that is the same as that of FIG. 12 other than the time stamp encoded in step 1310 is less than that in step 1210 such that the procedure is performed in an accelerated way as compared to that of FIG. 12, in accordance with one embodiment of the present disclosure. Since the message flows are the same, the details are not repeated. Steps 1300-1332 correspond to steps 1200-1232 described above, other than the following differences.

In this embodiment, the time stamp for when the toggled first latency spin bit is received by the server 606 in step 1308 (and likewise in step 1318) is encoded as a fraction of the relative time stamp. More specifically, the server 606 sends the packet with the toggled second latency spin bit in step 1310 at time T′₂+f*(T′₂−T′₀) and sends the packet with the toggled second latency spin bit in step 1322 at time T′₆+f*(T′₆−T′₀). Here, “f” is the acceleration factor that is greater than 0 and less than 1. For example, f may be 0.1.

At the observation function 608:

$${T}_{2}^{′} - {T}_{0}^{′} = ( {T}_{4} - {T}_{3} ) / f$$

such that the first one-way delay (D₁) can be computed by the observation function 608 as:

$${D}_{1} = Δ + ( {T}_{4} - {T}_{3} ) / f - {T}_{1} .$$

Likewise, the first one-way delay for the second measurement cycle (D₁(2)), if performed, can be computed by the observation function 608 as:

$${D}_{1} ( 2 ) = Δ + ( {T}_{8} - {T}_{7} ) / f - {T}_{5} .$$

The rest of the formulas are the same as above.

The benefit of this embodiment as compared to that of FIG. 12 is twofold:
The time between receiving the toggled first latency spin bit at the server 606 and sending that toggled second latency spin bit is smaller in the embodiment of FIG. 13. Therefore, the probability that transport conditions change is lower. The accuracy of the one-way latency estimation is higher.
The observation function 608 receives the required information for computing the one-way latency value(s) earlier. Therefore, the results are available faster. This may be important in closed loop use cases when corrective action should be done quickly in order to avoid end user service degradation.

### 1.4 Example Implementations

FIG. 14 illustrates one example embodiment in which the procedure of FIG. 12 or FIG. 13 is utilized to compute a measurement of an end-to-end delay between a UE 212 and a UPF 314. Optional steps are represented by dashed lines/boxes. As illustrated, the gNB 202 and the UE 212 perform the procedure of FIG. 12 or FIG. 13 to obtain a measurement of the one-way delay between the UE 212 and the gNB 202 (step 1400). In step 1400, the gNB 202 operates as the first node 602-1 of FIG. 12 or FIG. 13, where the gNB 202 includes the client 604 and the observation function 608, and the UE 212 operates as the second node 602-2 of FIG. 12 or FIG. 13, where the UE 212 includes the server 606. In addition, the gNB 202 and the UPF 314 perform the procedure of FIG. 12 or FIG. 13 to obtain a measurement of the one-way delay between the gNB 202 and the UPF 314 (step 1402). In step 1402, the gNB 202 operates as the first node 602-1 of FIG. 12 or FIG. 13, where the gNB 202 includes the client 604 and the observation function 608, and the UPF 314 operates as the second node 602-2 of FIG. 12 or FIG. 13, where the UPF 314 includes the server 606. Note that a single observation function 608 at the gNB 202 performs the actions or steps of the observation function 608 in steps 1402 and 1404. The gNB 202 (e.g., the observation function 608) computes a measurement of the end-to-end (one-way) delay between the UE 212 and the UPF 314 based on (e.g., by summing) the one-way latencies computed in steps 1400 and 1402 (step 1404). The gNB 202 may then perform one or more operational tasks based on the end-to-end delay and/or the one-way latencies computed in steps 1400 and 1402, and/or the gNB 202 may send the end-to-end delay and/or the one-way latencies computed in steps 1400 and 1402 to another node (step 1406). For example, if the end-to-end delay is higher than a predefined or configured threshold end-to-end delay, the gNB 202 may perform one or more actions to reduce the end-to-end delay (e.g., allocate more radio resources to the UE 212, trigger or request a change in routing of traffic for the UE 212 in the core network (e.g., a new UPF selection), or the like. As another example, the gNB 202 may send the computed end-to-end delay and/or the one-way latencies computed in steps 1400 and 1402 to an analytics function (e.g., a NWDAF).

FIG. 15 illustrates one example embodiment in which the procedure of FIG. 12 or FIG. 13 is utilized to compute various one-way delays between nodes in an end-to-end path between a UE 212 and a UPF 314. Optional steps are represented by dashed lines/boxes. As illustrated, the gNB 202 and the UE 212 perform the procedure of FIG. 12 or FIG. 13 to obtain a measurement of the one-way delay between the UE 212 and the gNB 202 (step 1500). In step 1500, the gNB 202 operates as the first node 602-1 of FIG. 12 or FIG. 13, where the gNB 202 includes the client 604 and the observation function 608, and the UE 212 operates as the second node 602-2 of FIG. 12 or FIG. 13, where the UE 212 includes the server 606. In addition, the UPF 314 and the UE 212 perform the procedure of FIG. 12 or FIG. 13 to obtain a measurement of the one-way delay between the UPF 314 and the UE 212 (step 1502). In step 1402, the UPF 314 operates as the first node 602-1 of FIG. 12 or FIG. 13, where the UPF 314 includes the client 604 and the observation function 608, and the UE 212 operates as the second node 602-2 of FIG. 12 or FIG. 13, where the UE 212 includes the server 606. Note that separate observation functions 608 at the gNB 202 and the UPF 314 perform the actions or steps of the observation function 608 in steps 1402 and 1404, respectively. The gNB 202 sends the computed one-way latency of step 1500 to the UPF 314 and/or the UPF 314 sends the computed one-way latency of step 1502 to the gNB 212 (step 1504). Using the information from steps 1500 and 1502, the gNB 202 or the UPF 314 computes the one-way latency between the gNB 212 and the UPF 314 (step 1504). The one-way latency between the gNB 202 and the UPF 314 may be computed as the one-way latency between the UE 212 and the UPF 314 (which is the end-to-end latency) minus the one-way latency between the UE 212 and the gNB 202 (computed in step 1500). The gNB 212 and/or the UPF 314 may then use the latencies computed in steps 1500, 1502, and/or 1504 for one or more operational tasks (e.g., to trigger performance of an action(s) to reduce the one-way latencies) and/or send the latencies computed in steps 1500, 1502, and/or 1504 to one or more other nodes (e.g., an analytics function such as, e.g., an NWDAF) (step 1506).

### 2 Realization in PDCP Layer

The following describes one example realization of an embodiment of the present disclosure in which the first and second latency spin bits are sent in the PDCP layer. In this example, the first and second latency spin bits are a first and second bits in the PDCP (or SDAP) packet header and used for RTT and/or one-way latency measurement between a UE 212 and gNB 202. While the following focuses on embodiments in which both the first and second latency spin bits are used, in some embodiments, only the first latency spin bit may be used (and, e.g., included in the definition of the PDCP or SDAP header).

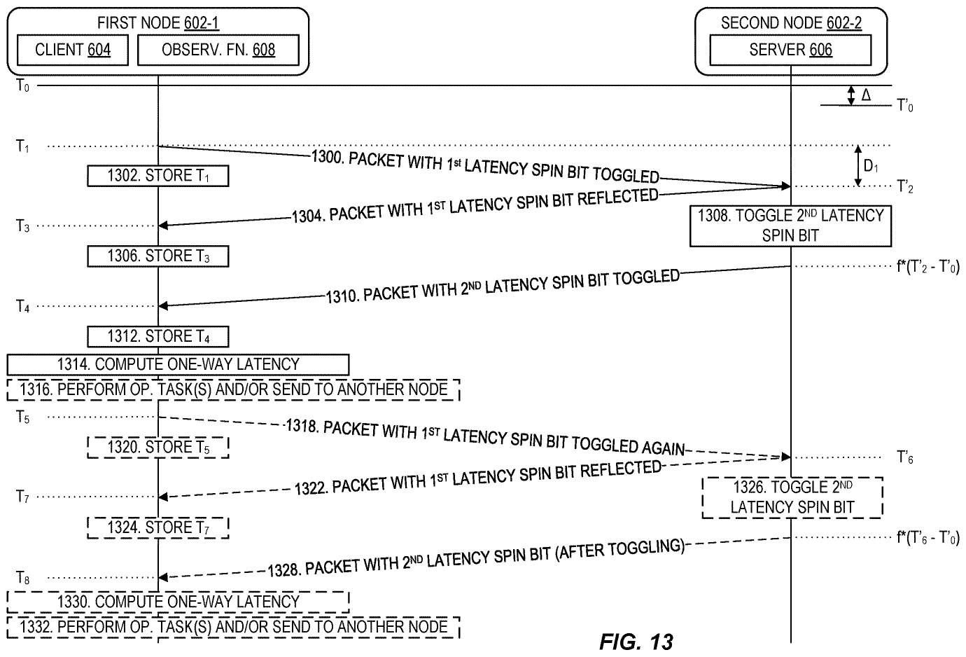

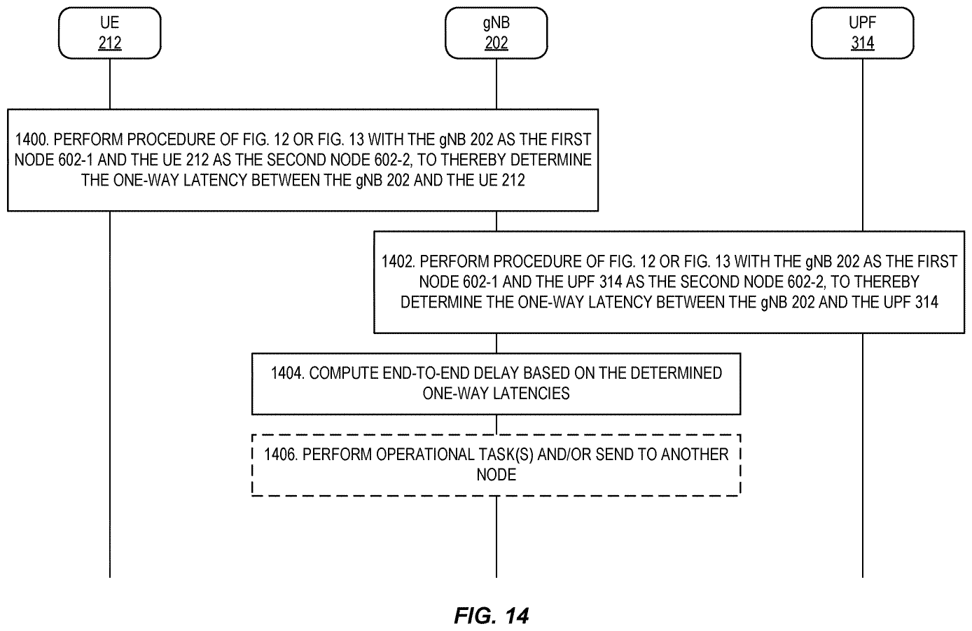

In the case of PDCP, in the current 3GPP specifications, there are three to five reserved bits available in the data PDU that can be used for the first and second latency spin bits depending on the used format of the PDCP sequence number, as shown in FIG. 16 (PDCP Data PDU Format with 12 bits PDCP Sequence Number) and FIG. 17 (PDCP Data PDU Format for Data Radio Bearers (DRBs) with 8 bits PDCP Sequence Number). Any of the reserved (R) bits or a combination of them can be defined as the first and second latency spin bits.

### 3 Realization in GTP LAYER

The following describes one example realization of an embodiment of the present disclosure in which the first and second latency spin bits are sent in the GTP layer. In this example, the first and second latency spin bits are a first and second bits in the GTP header and used for RTT and/or one-way latency measurement between a gNB 202 and UPF 314. While the following focuses on embodiments in which both the first and second latency spin bits are used, in some embodiments, only the first latency spin bit may be used (and, e.g., included in the definition of the GTP header).

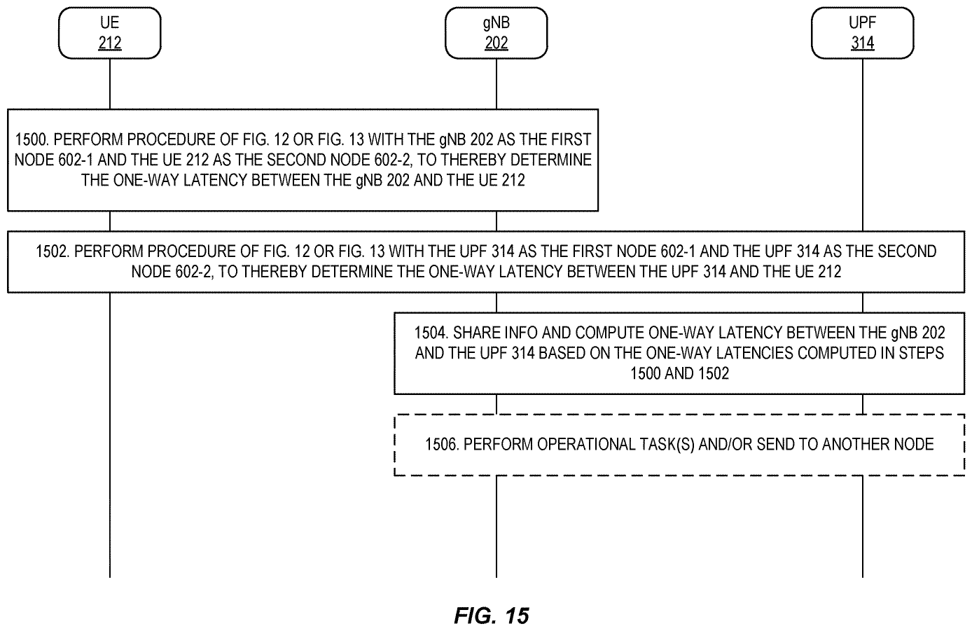

As shown in FIG. 18, in current 3GPP specifications, there is at least one spare bit in the GTP header that is, in one embodiment, uses for either the first latency spin bit or the second latency spin bit. This spare bit is marked as (*) in the example of the GTP header shown in FIG. 18. In embodiment, an extension header is also defined to enable the other of the first and second latency spin bits or, alternatively, both the first and second latency spin bits could be defined in the extension header. As another alternative, the spare bit in the current GTP header may be used for the first latency spin bit and another bit in the current GTP header may be redefined as the second latency spin bit, or vice versa. In yet another alternative, two bits in the current GTP header (other than the spare bit) may be re-defined as the first and second latency spin bits.

### 4 Enable Round Trip Measurement in Case of One-Way Traffic

Most of the traffic types in mobile networks are bidirectional, which means that there are continuous user packet streams in both the uplink and downlink directions. Thus, in one embodiment, latency spin bits may be used in both directions and used to measure RTT and/or one-way latency. In case of unidirectional traffic, and in the case when there are silence periods without user packets in one of the directions, dummy or silence packets or control PDUs are sent with a reasonable period (e.g., a predefined or configured period), in order to enable the use of the first and second latency spin bits to estimate RTT and one-way latency as described herein. In one embodiment, the period of sending these packets is at least 1 or 2 orders of magnitude smaller than the RTT.

### 5 Use Case Examples

### 5.1 Using RTT as Input to Service Quality Models

The technical solution makes possible to measure and report the e2e UL and DL delays with high time resolution. The maximum time resolution is basically the RTT. Per flow network and service quality analytics tools implement service quality machine learning models based on high-resolution transport reports. For URLLC service types, the packet level latency is the key performance parameter. The high resolution UL and DL delay measurements, therefore, are appropriate input metrics for service quality models for URLLC service type.

### 5.2 Monitoring and Root Cause Analysis

The continuous RTT measurements are reported by the observer network probe or node. PDCP and SDAP measurements refer to the UL and DL radio IF while GTP measurements refer to the core network transport paths, configuration and NFs.

The measured PDCP/SDAP UL and DL delay values are aggregated per network cells, RAT type, frequency band, etc. radio dimensions. The GTP RTT are aggregated per NF, gateway addresses, slice IDs and other core network dimensions.

Bad PDCP/SDAP UL and DL delay values indicate issue in radio while bad GTP UL and DL delay values indicate issues in the core network domain. Latency issues can further localized by observing UL and DL delay for the different radio and core network dimensions, see above.

In core network UL and DL issues can be separated by observing KPIs in correlation with UL and DL delay gateway. Uplink and downlink radio issues can be separated by correlating bad DL delay values with DL radio parameters (e.g., RSRP, RSRQ, SINR) and bad UL delay values with UL radio parameters (e.g. uplink power meas. of different radio channels).

The root cause of the latency issue is identified by correlating UL and DL delay values with radio or core measurements. E.g., if DL delay values are correlating with bad RSRP value, the root cause if bad coverage (week signal) If bad DL delay correlates with RSRQ, the root cause of the latency issue is interference. If bad DL delay correlates with, e.g., a high drop rate and processor load in a core network NF instance, the root cause is overload in the given NF.

Note that correlation can be done per flow in event based monitoring systems, or per radio or core network entities. In this case it can be based on stat counters as well.

In summary, the monitoring and root cause detection process consist of the following steps:
1. Continuous monitoring and reporting of RTT UL and DL delay values
2. Identify bad direction UL or DL
3. Localization: identifying bad domain, cell or core network functions, paths, etc.
4. Correlating UL and DL delay values with radio parameters, core network parameters, measurements
5. Identify root cause

### 5.3 Using Uplink and Downlink e2e Delay in Closed Loop Assurance Function

Continuous monitoring of e2e delay can be used for closed loop service quality assurance solutions. Assume that a delay critical URLLC service has a target for e2e latency quantile, i.e. 99.9% of the time should be below 10 ms in downlink and 20 ms in uplink. When a service quality target violation is detected, different actions can be triggered for uplink and downlink latency issues, e.g.:
In case of a downlink latency issue, the radio scheduling priority of the bearer serving the given URLLC service type is increased, eliminating the queuing delay of packets belonging to this service types.
In case of an uplink latency issue, the UPF serving the traffic may be changed, modifying in this way the transport path to a faster alternative.

### 6 Further Description

Embodiments of the solutions described herein provide a number of advantages over existing technology. For example, embodiments of the present disclosure may provide an efficient way of establishing both RTT and one-way latency (e.g., uplink latency and/or downlink latency). As another example, in addition to providing a mechanism for RTT latency measurements for non-QUIC traffic, embodiments of the present disclosure may make it possible to separately measure RTT for the radio interface between the UE and gNB and RTT between gNB and the core network (e.g., RTT between the gNB and UPF). This enables identifying and localizing delay bottlenecks. It is further possible to correlate RTT between UE and gNB with radio counters and correlate gNB-UPF RTT with core network counters, which can be used for identifying root cause of delay issues.

As another example, embodiments of the present disclosure may enable detection of increased uplink or downlink delay in the RAN, in the core network, or end-to-end in a short amount of time.

As another example, embodiments of the present disclosure may enable delay issues to be associated directly to radio or core domains, as well as to uplink or downlink parameters, for root cause identification.

As another example, embodiments of the accelerated measurement solution decrease the probability of changing transport channel conditions during the measurement cycle and, as such, the delay estimation is more exact.

As another example, embodiments of the accelerated measurement solution may enable a short closed-loop service assurance function, namely, a function to detect and fix delay issues before the delay issues causes end-to-end service quality degradation. Further, by separately monitoring uplink and downlink delays, different actions can be done in a closed loop assurance function for uplink and downlink issues, resulting in more optimum closed loop solutions.

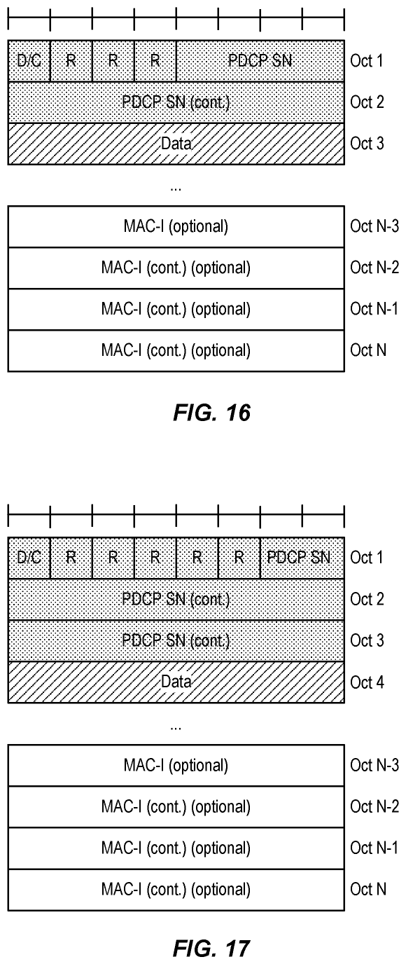

FIG. 19 is a schematic block diagram of a network node 1900 according to some embodiments of the present disclosure. Optional features are represented by dashed boxes. The network node 1900 may be, for example, a base station 202 (e.g., gNB), a network node that implements all or part of the functionality of the base station 202 or gNB, a core network node such as, e.g., a core network node that implements a UPF 314, or the like. As illustrated, the network node 1900 includes a control system 1902 that includes one or more processors 1904 (e.g., Central Processing Units (CPUs), Application Specific Integrated Circuits (ASICs), Field Programmable Gate Arrays (FPGAs), and/or the like), memory 1906, and a network interface 1908. The one or more processors 1904 are also referred to herein as processing circuitry. In addition, if the network node 1900 is a radio access node (e.g., a base station 202, gNB, or network node that implements at least some of the functionality of the base station 202 or gNB), the network node 1900 may include one or more radio units 1910 that each includes one or more transmitters 1912 and one or more receivers 1914 coupled to one or more antennas 1916. The radio units 1910 may be referred to or be part of radio interface circuitry. In some embodiments, the radio unit(s) 1910 is external to the control system 1902 and connected to the control system 1902 via, e.g., a wired connection (e.g., an optical cable). However, in some other embodiments, the radio unit(s) 1910 and potentially the antenna(s) 1916 are integrated together with the control system 1902. The one or more processors 1904 operate to provide one or more functions of the network node 1900 as described herein (e.g., one or more functions of a base station 202 or gNB described herein or one or more functions of a core network node (e.g., UPF) described herein). In some embodiments, the function(s) are implemented in software that is stored, e.g., in the memory 1906 and executed by the one or more processors 1904.

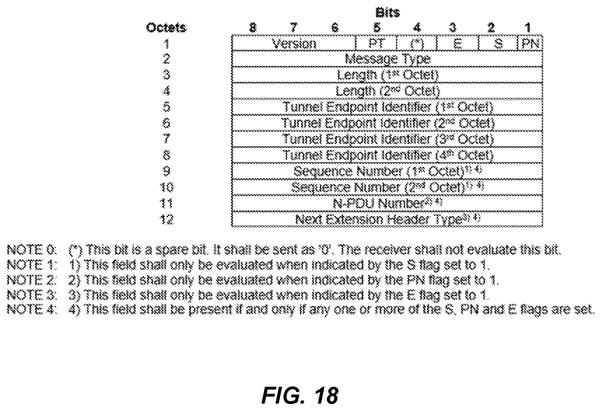

FIG. 20 is a schematic block diagram that illustrates a virtualized embodiment of the network node 1900 according to some embodiments of the present disclosure. Again, optional features are represented by dashed boxes. As used herein, a “virtualized” network node is an implementation of the network node 1900 in which at least a portion of the functionality of the network node 1900 is implemented as a virtual component(s) (e.g., via a virtual machine(s) executing on a physical processing node(s) in a network(s)). As illustrated, in this example, if the network node 1900 is a radio access node, the network node 1900 may include the control system 1902 and/or the one or more radio units 1910, as described above. The control system 1902 may be connected to the radio unit(s) 1910 via, for example, an optical cable or the like. The network node 1900 includes one or more processing nodes 2000 coupled to or included as part of a network(s) 2002. If present, the control system 1902 or the radio unit(s) are connected to the processing node(s) 2000 via the network 2002. Each processing node 2000 includes one or more processors 2004 (e.g., CPUs, ASICS, FPGAs, and/or the like), memory 2006, and a network interface 2008.

In this example, functions 2010 of the network node 1900 described herein (e.g., one or more functions of a base station 202 or gNB described herein or one or more functions of a core network node (e.g., UPF) described herein) are implemented at the one or more processing nodes 2000 or distributed across the one or more processing nodes 2000 and the control system 1902 and/or the radio unit(s) 1910 in any desired manner. In some particular embodiments, some or all of the functions 2010 of the network node 1900 described herein are implemented as virtual components executed by one or more virtual machines implemented in a virtual environment(s) hosted by the processing node(s) 2000. As will be appreciated by one of ordinary skill in the art, additional signaling or communication between the processing node(s) 2000 and the control system 1902 is used in order to carry out at least some of the desired functions 2010. Notably, in some embodiments, the control system 1902 may not be included, in which case the radio unit(s) 1910 communicate directly with the processing node(s) 2000 via an appropriate network interface(s).

In some embodiments, a computer program including instructions which, when executed by at least one processor, causes the at least one processor to carry out the functionality of the network node 1900 or a node (e.g., a processing node 2000) implementing one or more of the functions 2010 of the network node 1900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

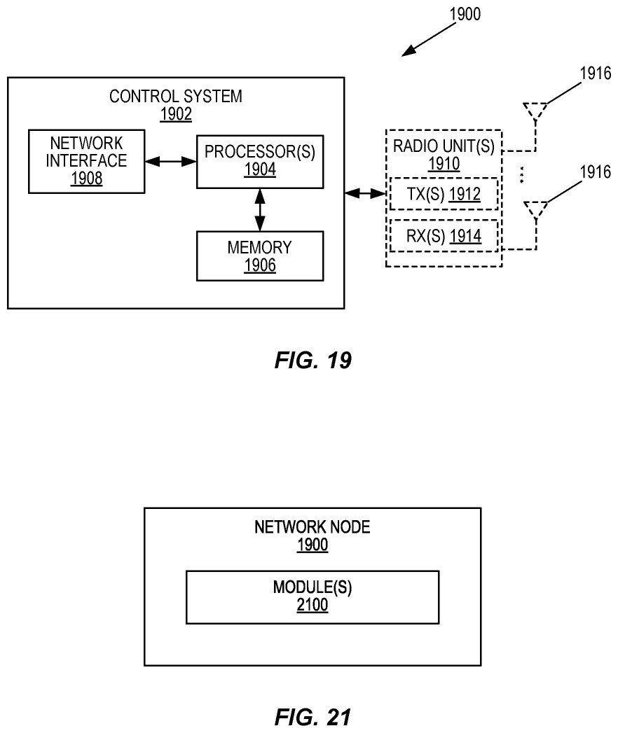

FIG. 21 is a schematic block diagram of the network node 1900 according to some other embodiments of the present disclosure. The network node 1900 includes one or more modules 2100, each of which is implemented in software. The module(s) 2100 provide the functionality of the network node 1900 described herein. This discussion is equally applicable to the processing node 2000 of FIG. 20 where the modules 2100 may be implemented at one of the processing nodes 2000 or distributed across multiple processing nodes 2000 and/or distributed across the processing node(s) 2000 and the control system 1902.

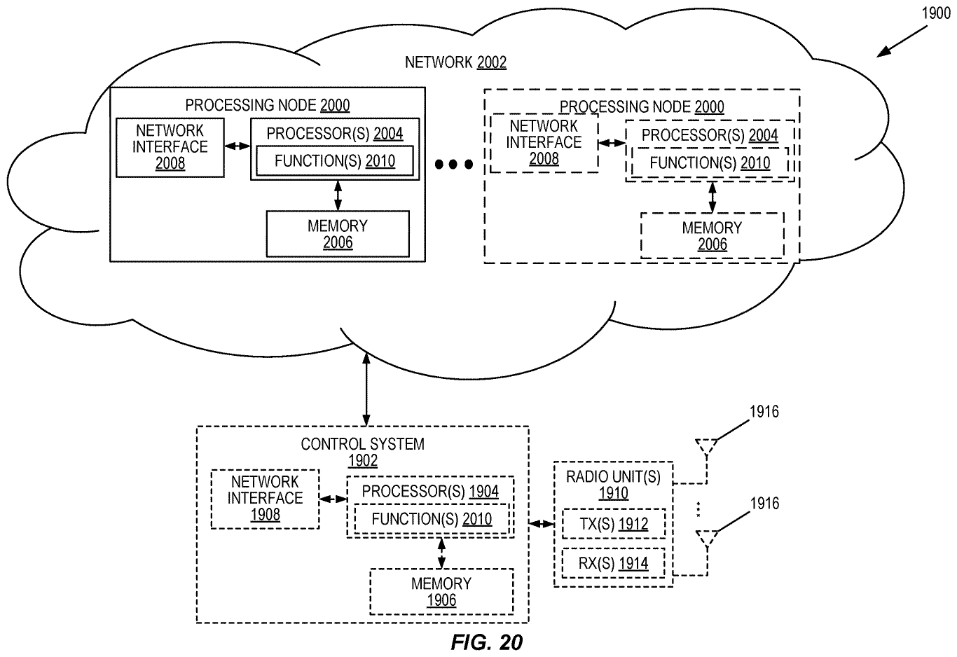

FIG. 22 is a schematic block diagram of a wireless communication device 212 (e.g., a UE) according to some embodiments of the present disclosure. As illustrated, the wireless communication device 212 includes one or more processors 2202 (e.g., CPUs, ASICS, FPGAs, and/or the like), memory 2204, and one or more transceivers 2206 each including one or more transmitters 2208 and one or more receivers 2210 coupled to one or more antennas 2212. The transceiver(s) 2206 includes radio-front end circuitry connected to the antenna(s) 2212 that is configured to condition signals communicated between the antenna(s) 2212 and the processor(s) 2202, as will be appreciated by on of ordinary skill in the art. The processors 2202 are also referred to herein as processing circuitry. The transceivers 2206 are also referred to herein as radio circuitry. In some embodiments, the functionality of the wireless communication device 212 (or UE) described above may be fully or partially implemented in software that is, e.g., stored in the memory 2204 and executed by the processor(s) 2202. Note that the wireless communication device 212 may include additional components not illustrated in FIG. 22 such as, e.g., one or more user interface components (e.g., an input/output interface including a display, buttons, a touch screen, a microphone, a speaker(s), and/or the like and/or any other components for allowing input of information into the wireless communication device 212 and/or allowing output of information from the wireless communication device 212), a power supply (e.g., a battery and associated power circuitry), etc.

In some embodiments, a computer program including instructions which, when executed by at least one processor, causes the at least one processor to carry out the functionality of the wireless communication device 212 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

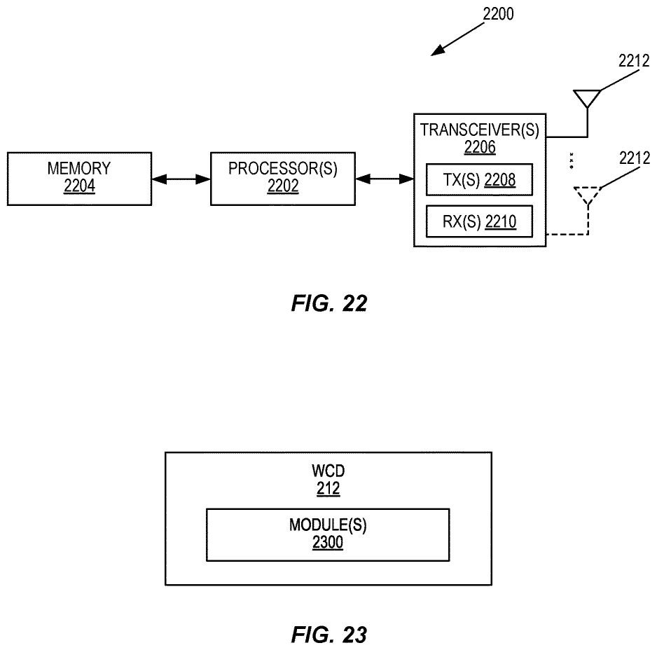

FIG. 23 is a schematic block diagram of the wireless communication device 212 according to some other embodiments of the present disclosure. The wireless communication device 212 includes one or more modules 2300, each of which is implemented in software. The module(s) 2300 provide the functionality of the wireless communication device 212 (or UE) described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1.-90. (canceled)

91. A method performed by a node that implements an observation function in a cellular communications system, the method comprising:
observing, at a first time in a first direction of a communication path between a first node of a cellular communications system and a second node of the cellular communications system, a packet with a first latency spin bit set to a first value;
storing the first time;
observing, at a second time in the first direction of the communication path between the first node of the cellular communications system and the second node of the cellular communications system, a packet with the first latency spin bit set to a second value;
storing the second time; and
computing a round trip time (RTT) for communication between the first node and the second node as a difference of the second time and the first time;
wherein the first latency spin bit is comprised in each of the packets at or above a Packet Data Convergence Protocol (PDCP) layer in a defined protocol stack of the cellular communications system.

92. The method of claim 91, wherein the first node is a User Equipment (UE), and the second node is a base station.

93. The method of claim 91, wherein the first node is a base station, and the second node is a core network node.

94. The method of claim 91, wherein the core network node is a User Plane Function (UPF).

95. The method of claim 91, wherein the first latency spin bit is comprised in a General Packet Radio Service (GPRS) Tunneling Protocol (GTP) header or an extension of a GTP header.

96. The method of claim 91, wherein the observation function is implemented at the second node.

97. The method of claim 91, wherein the observation function is implemented at the first node.

98. The method of claim 91, wherein the observation function is implemented at a third node that is in the communication path between the first node and the second node.

99. The method of claim 91, wherein the first node is a User Equipment (UE), and the second node is a core network node.

100. The method of claim 99, wherein the core network node is a User Plane Function (UPF).

101. The method of claim 99, wherein the observation function is implemented at a base station in the communication path between the UE and the core network node.

102. The method of claim 91, further comprising:
observing, at a third time in a second direction of the communication path between the first node of the cellular communications system and the second node of the cellular communications system, a packet that includes the first latency spin bit set to the second value;
storing the time;
observing, at a fourth time in the second direction of the communication path between the first node of the cellular communications system and the second node of the cellular communications system, a packet that includes a second latency spin bit that has been toggled;
storing the fourth time; and
computing a one-way latency for the first direction of the communication path between the first node of the cellular communications system and the second node of the cellular communications system, based on the first time, the third time, and the fourth time.

103. A base station comprising processing circuitry configured to cause the base station to:
observe, at a first time in a first direction of a communication path between a User Equipment (UE) of a cellular communications system and the base station of the cellular communications system, a packet with a first latency spin bit set to a first value;
store the first time;
observe, at a second time in the first direction of the communication path between the UE and the base station, a packet with the first latency spin bit set to a second value;
store the second time;
compute a first round trip time (RTT) for communication between the UE and the base station as a difference of the second time and the first time;
observe, at a third time in a first direction of a communication path between the base station and a core network node of the cellular communications system, a packet with a first latency spin bit set to a first value;
store the third time;
observe, at a fourth time in the first direction of the communication path between the base station and the core network node, a packet with the first latency spin bit set to a second value;
store the fourth time; and
compute a second RTT for communication between the base station and the core network node as a difference of the fourth time and the third time;
wherein:
the first latency spin bit comprised in each of the packets in the communication path between the UE and the base station is comprised at a Packet Data Convergence Protocol (PDCP) layer or SDAP layer in a defined protocol stack for communication between the UE and the base station; and
the first latency spin bit comprised in each of the packets in the communication path between the base station and the core network node is comprised in a GTP layer of a defined protocol stack for communication between the base station and the core network node.

104. A method performed by a second node of a cellular communications system, the method comprising:
receiving, at a time T′₂, a packet with a first latency spin bit that has been toggled from a first value to a second value from a first node of the cellular communications system;
in response to receiving the packet with the first latency spin bit that has been toggled:
sending a packet with the first latency spin bit set to the second value to the first node;
toggling a second latency spin bit; and
sending, at a time that encodes T′₂−T′₀, a packet with a second latency spin bit that has been toggled from a first value to a second value, where T′₀ is a reference time at the second node;
wherein the first latency spin bit and the second latency spin bit are each comprised in the respective packet at or above a Packet Data Convergence Protocol (PDCP) layer in a defined protocol stack of the cellular communications system.

105. The method of claim 104, wherein the time that encodes T′₂−T′₀ is a time 2*(T′₂−T′₀).

106. The method of claim 104, wherein the time that encodes T′₂−T′₀ is a time f*(T′₂−T′₀), where f is a predefined or configured factor that is greater than 0 and less than 1.

107. A second node for a cellular communications system, the second node comprising processing circuitry configured to cause the second node to perform the method of claim 104.

108. A second node for a cellular communications system, the second node comprising processing circuitry configured to cause the second node to:
receive, at a time T′₂, a packet with a first latency spin bit that has been toggled from a first value to a second value from a first node of the cellular communications system;
in response to receiving the packet with the first latency spin bit that has been toggled:
send a packet with the first latency spin bit set to the second value to the first node; and
toggle a second latency spin bit; and
send, at a time that encodes T′₂−T′₀, a packet with a second latency spin bit that has been toggled from a first value to a second value, where T′₀ is a reference time at the second node;
wherein the first latency spin bit and the second latency spin bit are each comprised in the respective packet at or above a Packet Data Convergence Protocol (PDCP) layer in a defined protocol stack of the cellular communications system.

109. The second node of claim 108, wherein the processing circuitry is further configured to cause the second node to perform the method of claim 104.
